(19) United States
(12) Patent Application Publication
(10) Pub. No.: US 2026/0086932 A1
(43) Pub. Date: Mar. 26, 2026

(54) METHOD, SYSTEM, AND COMPUTER PROGRAM PRODUCT FOR ADAPTIVE MEMORY MANAGEMENT FOR DATA INGESTION AND FLUSH

(71) Applicant: Oracle International Corporation, Redwood Shores, CA (US)

(72) Inventors: Aurosish Mishra, Redwood Shores, CA (US); Kam Shergill, Reading (GB); Naga Balaji Thirukondaa, Bengaluru (IN)

(73) Assignee: Oracle International Corporation, Redwood Shores, CA (US)

(21) Appl. No.: 18/924,947

(22) Filed: Oct. 23, 2024

Related U.S. Application Data
(60) Provisional application No. 63/697,999, filed on Sep. 23, 2024.

(51) Int. Cl. G06F 12/02

(52) U.S. Cl. CPC G06F 12/023

(57) ABSTRACT

Described is an improved approach to implement memory management. A predicted ingest rate and a predicted flush rate is determined for a memory area of a global memory for a database. A memory management task is determined for the memory area based at least in part upon the predicted ingest rate and the predicted flush rate. A buffer accessibility map is modified based at least in part upon the memory management task; and the memory area is adaptively resized at least by executing the memory management task on the memory area.

### RELATED APPLICATIONS

The present application is a continuation of U.S. Provisional Application Ser. No. 63/697,999 titled “METHOD, SYSTEM, AND COMPUTER PROGRAM PRODUCT FOR ADAPTIVE MEMORY MANAGEMENT FOR DATA INGESTION AND FLUSH”, filed on Sep. 23, 2024, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

With the Internet of Things (IoT), applications generate a lot of informational data such as data from various sensors, smart meter data, data from various surveillance cameras, security cameras, traffic cameras, etc. When compared to transactional data of database transactions, these various types of data may be important or may have value in the aggregate but may not necessarily always require ACID (atomicity, consistency, isolation, and durability) guarantees. For such applications, the ability of a system to ingest data at a rapid rate may be important to enable, for example, “sense-and-respond” behaviors (e.g., examining the ingested data in real-time or nearly real-time and detect anomalous behaviors). Data ingestion thus refers to and comprise a process of importing or receiving large, various types of data files or pieces from multiple sources into a single, cloud-based storage medium (e.g., a data warehouse, data mart or database) where the received or imported data may be accessed and analyzed.

Conventional data ingestion approaches handle high-volume data ingestion by have the foreground sessions insert the data into an in-memory area while bypassing the heavy-weight transactional checks and disk writers of the database. Once the data is stored in memory, the writes of such ingested data are acknowledged to the user. These conventional approaches further batch multiple single-row inserts together and bulk write the data from the in-memory area into data blocks of a table (e.g., a database table) or a persistent storage therefor using, for example, array inserts, leveraging special code-paths that directly go into the data layer without navigating through the upper half code while these background flush processes and the aforementioned foreground processes are oftentimes executed asynchronously.

Moreover, these conventional approaches utilize a fixed, static size in-memory area that is often not only fixed but also decided at the time of allocation. This static nature of the in-memory area for data ingestion in these conventional approaches creates several problems. For example, when a workload's activity increases, and the rate of inserts exceeds the rate of flush, new inserts must wait for at least some buffers in this in-memory area to be flushed so that the space may be freed up to accommodate these new inserts. For fast data ingestion, such wait time may stall applications and negate the benefits of having fast data ingestion in the first place. On the other hand, if a workload's insert activity decreases, the memory allocated for data ingestion may remain underutilized for a period of time. In this scenario, given that the memory is allocated from, for example, the system global area (SGA), which is usually a precious resource in any database deployment, especially in shared autonomous database deployments, such underutilized memory due to decreased workload activity may constitutes a waste of such precious resources.

What is needed is therefore a method, system, and computer program products for memory management to improve the utilization of computer resources and to address at least the aforementioned problems and shortcomings of conventional approaches.

### SUMMARY

According to some embodiments, the present disclosure provides a method in the computer technological field as well as the database technological field. In these embodiments, a memory area of a global memory of a computing system may be identified, wherein the memory area comprises a buffer memory area and is allocated for ingesting data for a database. A persistent storage device into which data stored in the memory area is to be flushed may also be identified.

Moreover, a predicted ingest rate and a predicted flush rate is determined for a memory area of a global memory for a database. A memory management task is determined for the memory area based at least in part upon the predicted ingest rate and the predicted flush rate. A buffer accessibility map or bucket mask is modified based at least in part upon the memory management task; and the memory area is adaptively resized at least by executing the memory management task on the memory area. A memory management task may be determined for the memory area based at least in part upon the predicted ingest rate and the predicted flush rate.

In some of these embodiments, an adaptive growth criterion and an adaptive growth size or rate may be determined for the memory area; and an adaptive shrink criterion and an adaptive shrink size or rate may also be determined for the memory area. In some of the preceding embodiments, determining the predicted ingest rate and the predicted flush rate may include identifying multiple snapshots pertaining to ingestion of first data into the memory area or flush of second data to the database or a persistent storage device therefor. For a snapshot of the multiple snapshots, an ingest rate and a flush rate may be determined, wherein multiple ingest rates and multiple flush rates are respectively determined for the multiple snapshots.

In some of these embodiments, a statistical ingest rate may be determined as the predicted ingest rate using at least the ingest rate determined for the snapshot of the multiple snapshots. A statistical flush rate may be determined as the predicted flush rate using at least the flush rate determined for the snapshot of the multiple snapshots.

In some of the immediately preceding embodiments, a model may be trained into a trained model using training data for data ingestion and data flushing, wherein the training data comprises the predicted ingest rate and the predicted flush rate; and the predicted ingest rate and the predicted flush rate may be determined by the trained model.

In some embodiments, determining the memory management task for the memory area may include comparing the statistical ingest rate to or with the statistical flush rate for generating a comparison result. The memory management task may be determined based at least in part upon the comparison result.

In some of the immediately preceding embodiments, determining the statistical ingest rate or the statistical flush rate may comprise determining one or more ingestion metrics or characteristics for ingestion of the first data or one or more flush metrics or characteristics for flushing the second data. Respective weights or multipliers may be determined for the multiple snapshots. The statistical ingest rate may be determined based at least in part the multiple ingest rates and the respective weights or multipliers or the statistical flush rate based at least in part the multiple flush rates and the respective weights or multipliers.

In addition or in the alternative, determining the memory management task for the memory area may include determining total waited ingestion time after shrinkage of the memory area. A determination may be made to decide whether to override the memory management task based at least in part upon whether the total waited ingestion time after the shrinkage of the memory area exceeds ac threshold.

In addition or in the alternative, determining the statistical ingest rate or the statistical flush rate may include determining a plurality of attributes pertaining to the database. A signature may be determined for an object of a plurality of objects, wherein the plurality of objects comprise data stored in the memory area, and a plurality of signatures are respectively determined for the plurality of objects, wherein the signature comprises a pattern of multiple bits each of which respectively represents presence or absence of a respective attribute of the plurality of attributes.

In some of the immediately preceding embodiments, determining the statistical ingest rate or the statistical flush rate may include for a signature of the plurality of signatures or an attribute of the plurality of attributes, identifying the snapshot from the multiple snapshots. for the signature identified from the plurality of signatures and the snapshot identified from the multiple snapshots, the ingest rate and the flush rate may be determined based at least in part upon the plurality of attributes, wherein the multiple ingest rates and the multiple flush rates are respectively determined for the multiple snapshots.

In some of the immediately preceding embodiments, determining the statistical ingest rate or the statistical flush rate may include determining the statistical ingest rate at least by performing a first statistical operation on the multiple ingest rates. The statistical flush rate may be determined at least by performing a second statistical operation on the multiple flush rates.

In some of the immediately preceding embodiments, a total number of tables that are enabled or are to be enabled for ingestion of the first data may be determined. The statistical ingest rate may be determined for the signature of the plurality of signatures based at least in part upon a count of objects for the signature across the multiple snapshots and a current number of objects for signature across the multiple snapshots. The statistical flush rate may also be determined for the signature of the plurality of signatures based at least in part upon the count of objects for the signature across the multiple snapshots and the current number of objects for signature across the multiple snapshots.

Some embodiments are directed at a hardware system that may be invoked to perform any of the methods, processes, or sub-processes disclosed herein. The hardware system may include at least one processor or at least one processor core, which executes one or more threads of execution to perform any of the methods, processes, or sub-processes disclosed herein in some embodiments. The hardware system may further include one or more forms of non-transitory machine-readable storage media or devices to temporarily or persistently store various types of data or information. Some exemplary modules or components of the hardware system may be found in the System Architecture Overview section below.

Some embodiments are directed at an article of manufacture that includes a non-transitory machine-accessible storage medium having stored thereupon a sequence of instructions which, when executed by at least one processor or at least one processor core, causes the at least one processor or the at least one processor core to perform any of the methods, processes, or sub-processes disclosed herein. Some exemplary forms of the non-transitory machine-readable storage media may also be found in the System Architecture Overview section below.

Other additional objects, features, and advantages of the present disclosure are described in the detailed description, figures, and claims.

### BRIEF DESCRIPTION OF FIGURES

The drawings illustrate the design and utility of some embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosures briefly described above will be rendered by reference to specific embodiments thereof, which are illustrated in the accompanying drawings. Understanding that these drawings depict only typical embodiments of the disclosure and are not therefore to be considered limiting of its scope, the disclosure will be described and explained with additional specificity and detail through the use of the accompanying drawings in which:

FIG. 1A illustrates a schematic example of a portion of a system 100A for adaptive memory management for data ingestion and flush according to some embodiments of the present disclosure.

FIG. 1B illustrates more details about the schematic example of the portion of the system 100 for adaptive memory management for data ingestion and flush according to some embodiments of the present disclosure.

FIG. 1C illustrates a high-level block diagram for a method or system for adaptive memory management for data ingestion and flush according to some embodiments of the present disclosure.

FIG. 2A shows more details about a portion of the high-level block diagram illustrated in FIG. 1C in some embodiments.

FIG. 2B shows more details about a portion of the high-level block diagram illustrated in FIG. 1C in some embodiments.

FIG. 2C shows more details about a portion of the high-level block diagram illustrated in FIG. 1C in some embodiments.

FIG. 2D shows more details about a portion of the block diagram illustrated in FIG. 2B in some embodiments.

FIG. 2E shows more details about a portion of the block diagram illustrated in FIG. 2B in some embodiments.

FIG. 2F shows more details about a portion of the high-level block diagram illustrated in FIG. 1C in some embodiments.

FIG. 2G shows more details about a portion of the block diagram illustrated in FIG. 2B in some embodiments.

FIG. 2H shows more details about a portion of the block diagram illustrated in FIG. 2B in some embodiments.

FIG. 2I shows more details about a portion of the block diagram illustrated in FIG. 2B in some embodiments.

FIGS. 3A-3C illustrate some simplified examples for adaptive memory management for data ingestion and flush according to some embodiments.

FIGS. 4A-4C illustrate some simplified examples for adaptive memory management for data ingestion and flush according to some embodiments.

FIGS. 5A-5H illustrate some simplified examples for adaptive memory management for data ingestion and flush according to some embodiments.

FIG. 6 is a block diagram of an illustrative computing system suitable for implementing one or more embodiments of the present disclosure.

FIG. 7 is a block diagram of one or more components of a system environment in which services may be offered as cloud services, in accordance with an embodiment of the present disclosure.

### DETAILED DESCRIPTION

Various embodiments will now be described in detail, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, various embodiments encompass present and future known equivalents to the components referred to herein by way of illustration.

For the sake of illustration, and not by way of limitation, the following description and illustrative examples are provided in the context of monitoring and performance improvement for a database management system. The description may further explain concepts by illustratively describing the embodiments of the invention in the context of estimating and monitoring network behavior. It is noted, however, that the invention has applicability beyond just databases and network behavior, and thus is not intended to be limited in its applicability to just these illustrative examples.

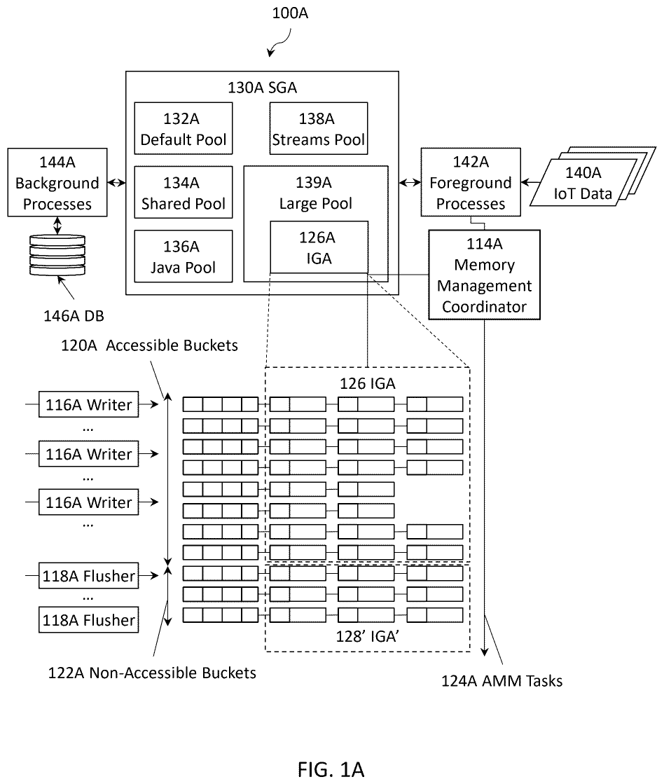

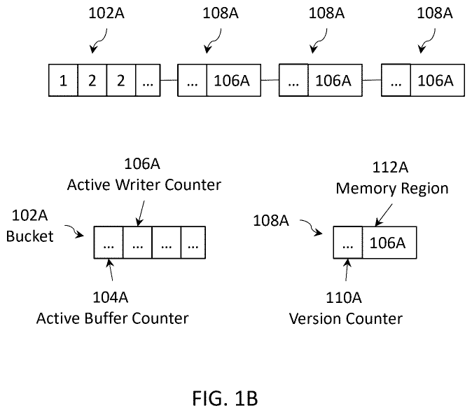

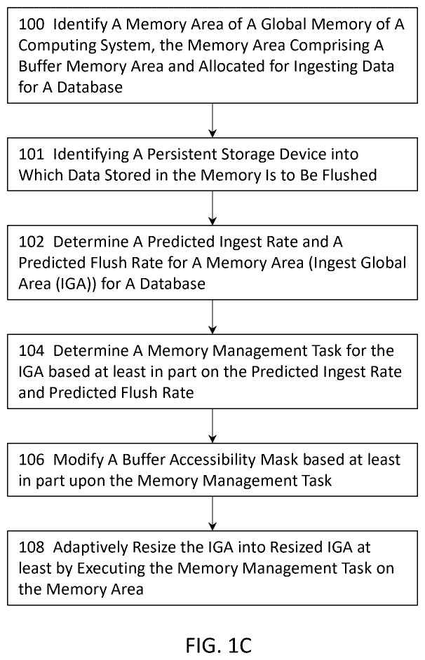

FIG. 1A illustrates a simplified schematic example of a portion of a system 100A for adaptive memory management for data ingestion and flush according to some embodiments of the present disclosure. In these embodiments, the system 100A may include a system global area (SGA) 130A which includes a shared memory area (e.g., a shared memory area in the random-access memory or RAM) that is used by one or more instances to store information or data that is to be shared between, for example, the database and one or more user processes. The SGA 130A may be accessed by one or more foreground processes 142A that receive or import data 140A (e.g., IoT or Internet of Things data). One or more background processes 144A may also access the SGA 130A. For example, one or more flusher processes (144A) may be coordinated to flush at least some of the SGA to a database table 146A or the persistent storage of the database 146A therefor. A system global area (SGA) includes a shared memory area that is used by a software instance (e.g., a database instance) to store information at least some of which is shared between the software instance and one or more user or client processes in some embodiments. In some of these embodiments, a system global area is allocated from the system memory (e.g., random access memory or RAM).

The system global area 130A may include one or more major components such as a default pool 132A, a shared pool 134A, a Java pool 136A, a streams pool 138A, and/or a large pool 139A, etc. in some embodiments. A default pool 132A accommodates the default database buffer cache or default buffer pool containing data blocks from schema objects that are not assigned to any buffer pool and/or schema objects explicitly assigned to the default pool for the database 146A. A shared pool 134A may include, for example, a library cache (e.g., the shared SQL areas, private SQL areas (in the case of a multiple transaction server), and/or PL/SQL procedures and packages, etc.), dictionary cache, and/or control structures such as locks and library cache handles that are accessible by all users in some embodiments. A Java pool 136A may provide the functionality of parsing Java code, scripts, and procedures, installation tasks related to Java applications, etc. A streams pool comprises a shared resource such as a RAM buffer area that may be used by a process, an application, a service, etc. for purposes such as streams replication, messages for streams and queuing, memory for streams capture and apply processes, etc.

A large pool 139A provides memory allocations for session memory for a shared server and a transaction interface for database transactions that interact with one or more databases, I/O (input/output) server processes, backup and restore operations, and/or parallel execution message buffers, etc. When compared to a shared pool (e.g., 134A) which may include a few hundred kilobytes of memory allocation in some cases, a large pool 139A may better satisfy large memory requests, especially for backup and restore operations. For data ingestion, a large pool 139A may include an in-memory area 126A (referred to as an Ingest Global Area or IGA) which comprises allocation of memory (e.g., RAM) for receiving or importing data 140A from, for example, various data sources via one or more foreground processes 142A. In some embodiments, a large pool 139A may include one or more parallel execution buffers that may store therein, for example, messages for parallel messages. An ingest global area (IGA) includes a shared memory area that is used by a software instance (e.g., a database instance) to store information at least some of which is shared between the software instance and one or more user or client processes in some embodiments. In some of these embodiments, an ingest global area is allocated from and comprises a smaller portion of the system memory (e.g., random access memory or RAM). In some embodiments, an ingest global area is allocated from and comprises a smaller portion of the aforementioned system global memory (SGA) (e.g., a smaller portion of a large pool in the system global area).

Data ingestion is the process of obtaining and importing data for immediate use or storage in a database or another type of data structure, according to some embodiments. To ingest data is to take the data in or absorb the data. Data may be streamed in real time or ingested in batches. In real-time data ingestion, each data item is imported as the source emits it. When data is ingested in batches, data items are imported in discrete chunks at periodic intervals of time. The first step in an effective data ingestion process is to prioritize the data sources. Individual files must be validated, and data items are routed to the correct destinations.

To illustrate the configuration and functionality of the IGA 126A, one or more writer processes 116A may write data 140A from, for example, Internet of Things (IoT) data from one or more data sources, into the IGA 126A, and/or one or more flusher processes 118A may flush the data in the IGA to a table (e.g., a database table) or a persistent storage therefor (e.g., a persistent storage such as one or more disks, solid state drives, or a persistent memory for the database 146A).

The IGA 126A may include one or more granules (not shown) each of which has one or more buckets. A granule is a unit of contiguous memory allocation in the SGA (Shared Global Area), and hence by extension, the IGA, according to some embodiments of the present disclosure. A granule can be shared by multiple 1 MB IGA buffers that are allocated into one or more buckets. A bucket in a granule may include one or more buffers of a fixed size (e.g., 1 MB of contiguous memory space for each buffer) or multiple, different sizes. A buffer comprises a contiguous memory space and provides a logical abstraction over granules. In some embodiments, each bucket in the IGA 126A has about the same number of buffers. For example, all buffers in the plurality of buckets of the IGA 126A may have the same number of buffers (e.g., three buffers for each bucket) in some embodiments. In some other embodiments, some buffers in the plurality of buckets have the same first number of buffers (e.g., 3, 4, 5, etc.) while the total number of buffers in each remaining bucket of the remaining one or more buckets may be more or less than the same first number of buffers by a fixed number.

In the example illustrated in FIG. 1A, most of the plurality of buckets have three buffers, and two buckets have one fewer buffer than the most of the plurality of buckets. In some embodiments, the buffers in a bucket are connected through a singly linked list, and the buckets or information therefor in the IGA 126A may be stored in a hash table (hereafter referred to an IGA hash table) that organizes the buffers in the IGA 126A in a hash table format and uses a hash function to compute an index (or hash code) into an array of slots that respectively correspond to the buckets in the IGA 126A and store the values therefor. A writer process includes a foreground process which uses insert statements or special C-APIs (application programming interface) to write data into the IGA, and a flusher process (or simply a flusher) includes a background process responsible for flushing data from IGA buffers to database blocks.

In various embodiments described herein, the IGA 126A may be dynamically grown or shrunk. For example, a memory management coordinator process or service 114A may execute one or more automatic memory management (AMM) tasks 124A as one or more foreground processes 142A to allocate more memory from the SGA 130A or from the large pool 139A in the SGA to grow IGA 126A by IGA′ 128A. When IGA 126A is grown, the range of available buckets in the buffer accessibility map (also referred to as a bucket mask) increases. Similarly, the memory management coordinator process or service 114A may execute one or more automatic memory management (AMM) tasks 124A as one or more background processes 144A to deallocate memory from the IGA 126A to effectively shrink the IGA 126A and to return the deallocated memory back to the large pool 139A or the SGA 130A. When IGA 126A is shrunk, the active range of available buckets in the bucket mask is reduced. In some embodiments, the active range of available buckets indicated by the bucket mask is first reduced, and then the buffers for the corresponding buckets are deallocated after the bucket mask is reduced. In these embodiments, a memory management coordinator process or service 114A includes a background process responsible for growing or shrinking the IGA based at least in part on heuristics. In some of these embodiments, a single process or service computes or determines the heuristics as well as performs the shrink and growth tasks. In some other embodiments, computing or determining the heuristics, growing the IGA, and shrinking the IGA may be done via separate processes or services. Again, it shall be noted that the terms “buffer accessibility map” and “bucket map” may be used interchangeably throughout the present disclosure.

The plurality of buckets in the IGA may be accessed by one or more writer processes 116A that write data into the IGA and one or more flusher processes 118A to flush data from the IGA to a table (e.g., a database table) or a persistent storage therefor (e.g., a disk drive, a solid-state drive, a persistent memory, etc.) such as one or more disk drives, solid state drives, or a persistent memory for the database 146A. Writer processes and flusher processes access buffers in the IGA 126A by using the buffer accessibility map(s) or bucket masks (e.g., 120A indicating that the corresponding buckets or buffers thereof are accessible and 122A indicating that the corresponding buckets or buffers thereof are inaccessible) that comprise a data structure and indicate whether respective buffers are available.

In some embodiments, each bucket in a granule or the one or more buffers in the bucket may corresponds to a separate bucket mask or buffer accessibility map. In some other embodiments, each bucket in a granule or the one or more buffers in the bucket may correspond to one or more entries in a data structure (e.g., one or more entries in a row of a table) so that the data structure stores the corresponding entries for all of the buckets. In other embodiments, the bucket masks of all of the buckets in the IGA may be stored in more than one data structure.

For example, when a memory management coordinator 114A dynamically grows the IGA 126A to include the newly allocated memory IGA′ 128′ which may be initially “locked” by modifying the bucket mask 122A to indicate that these buckets corresponding to the bucket mask 122A are unavailable to the writer processes 116A. Similarly, when one or more flusher processes 118A are to flush the data in certain buckets to a table (e.g., a database table) or a persistent storage therefor, the corresponding bucket mask may also be updated to prevent writer processes to obtain and write to the buffers in these buckets. In some embodiments, a bucket mask comprises a counter indicating an active range of buckets in the IGA. In these embodiments, writer processes may only write data into the active range, and a bucket mask is thus used for concurrency control between writer processes and the memory management coordinator 114A to growth and shrink the IGA 126A via one or more automatic memory management tasks 124A.

Concurrency control among a writer process, a flusher process, and the memory management coordinator process or service may include upon determining that writer process requests a buffer, incrementing the active buffer counter for a bucket that comprises the requested buffer and incrementing the total active buffer counter (e.g., a global counter). Moreover, upon determining that a flusher process attempts to flush the contents of a buffer, decrementing the active buffer counter for the bucket that comprises the buffer to be flushed, decrementing the total active buffer counter (e.g., a global counter) by one to reflect that the buffer has been flushed. In addition, the memory management coordinator performs a check on the active buffer counter to ensure that the IGA shrink task is safe to operate on the bucket and then frees up the bucket as a part of an IGA shrink task.

Concurrency control among two writer processes and the memory management coordinator process or service may include increasing the bucket mask when growing the IGA and decreasing the bucket mask when shrinking the IGA. Moreover, after the bucket mask is decreased, the bucket may be deallocated as a part of the shrink operation. Upon determining that a writer process attempts to obtain and write to a buffer, a check may be performed on the bucket mask in a lockless fashion to determine whether a bucket comprises a free buffer. If so, a bucket latch may be obtained to lock the bucket. Another check may be performed on the bucket mask again to ensure that a buffer or the bucket is available so as to prevent multiple writers from competing for the same buffer. One of the reasons for this additional check is that a bucket latch imposed by a writer may not necessarily prevent another writer from landing on the same bucket because by examining the active writer counter and the active buffer counter for the bucket, a writer only knows that there is an available, accessible buffer in the bucket but may or may not necessarily know which buffer is available, accessible until the writer checks the version counter of each buffer in the bucket. As a result, multiple writers may land on the same bucket while searching for a free buffer. The writer process may then obtain the buffer by caching the address of the buffer in the writer and further by updating the version counter of the buffer (e.g., in the buffer's header) to indicate that this buffer is unavailable, inaccessible.

In some embodiments, a process for implementing concurrency control may include determining whether a buffer in a bucket is to be invalidated or whether the buffer is available, at least by performing CAS on the active writer counter associated with the bucket. In some embodiments, the writer process may determine whether the active writer counter is less than # of buffers in the buffer plus one (“1”) by using CAS. In these embodiments, the bucket is deemed available or the memory management coordinator process or service has not shrunk the buffer when it is determined that the active writer counter is less than the total of buffers. When the active writer counter value is determined to be less than the total number of buffers plus one, the writer process may obtain the buffer at least by caching the address of the buffer within the writer, increment the active writer counter by one, increment the active buffer counter for the bucket that comprises the buffer by one, and increment the total active buffer counter (e.g., a global counter) by one.

Upon determining that an IGA shrink task or operation is to deallocate a bucket, a first determination is made to determine that a flusher process flushes the content of a buffer. The active buffer counter for the bucket that includes the buffer and the total active buffer counter are both decremented. The memory management coordinator may perform a check on the active buffer counter to determine whether the active buffer counter value is zero (e.g., no active writes and no pending data to be flushed). Another check may be performed via CAS to determine whether the active writer counter value is zero.

In some embodiments where the active writer counter value is zero, the active writer counter value may be incremented to the total number of buffers in the bucket plus one for the bucket via CAS. Upon successful completion of CAS, the buffers in the bucket and the bucket itself may be freed. When the active writer counter value is non-zero or when CAS fails, the memory management coordinator process or service waits for a period of time and either retry the above process or bails out this cycle. After the checks by the memory management coordinator process or service, the bucket may be deallocated as a part of the IGA shrink operation.

When the active writer counter value equals the total number of buffers plus one (e.g., the bucket has been shrunk), a writer process invalidates its cached address of a buffer in the bucket, and the writer process determines whether another buffer is available at least by performing CAS on the active writer counter associated with the bucket or with another bucket.

FIG. 1B illustrates more details about the schematic example of the portion of the system 100 for adaptive memory management for data ingestion and flush according to some embodiments of the present disclosure. More particularly, FIG. 1B illustrates a simplified schematic representation of a bucket 102B. It shall be noted that the configuration of the bucket 102B is presented solely for the ease of illustration and description, and that other configurations are also contemplated to serve identical and/or similar purposes. In these embodiments, a bucket 102B may include a bucket mask 102A which comprises a data structure having a plurality of fields that correspond to a plurality of respective values as described herein. The example bucket 102B may also include one or more buffers 108A where each buffer 108A may correspond to or comprise a buffer header 110A storing information such as a version counter. Each buffer 108A further include a memory region 112A that is allocated from the large pool (e.g., 139A in FIG. 1A) to the IGA (e.g., 126A in FIG. 1A) for writer processes to write data into the memory region 112A of the buffer 108A.

A version counter may comprise a one-bit field storing a binary value (e.g., BIT, BOOL, BOOLEAN) in some embodiments or may comprise a multi-bit field storing an integer (e.g., INT, TINYINT, MEDIUMINT, INTEGER, BIGING), a floating-point or fixed-point number, etc.), a string (e.g., TEXT or ENUM), a character (CHAR), a variable length string (e.g., VARCHAR), a binary byte string (e.g., VARBINARY), a string with a maximum length limit (e.g., TINYTEXT, MEDIUMTEXT, LONGTEXT), or any other suitable value or symbol. Aversion counter may be used for concurrency control between writer and flusher processes. In an example where a version counter has integer values, an odd value may indicate that a buffer is “locked”, i.e., a writer process is modifying the buffer, or a flusher process is about to flush the buffer; and an even value indicates that the buffer is “unlocked”, i.e., writer processes are not actively modifying the buffer nor is a flusher process trying to flush the buffer. In some embodiments, even if the buffer is “unlocked”, this buffer may still “belong” to a writer process—it is just that the writer process is not actively modifying the buffer.

In some embodiments, a version counter may be updated by a compare-and-swap (CAS) instruction, without using any locking mechanisms. Compare-and-swap comprises an atomic instruction that compares the contents of a memory location with a given value and, only if they are the same, modifies the contents of that memory location to a new given value. Compare-and-swap may be done as a single atomic operation where the atomicity guarantees that the new value is calculated based on up-to-date information. On the other hand, if the value had been updated by another thread in the meantime, the write would fail. The result of compare-and-swap indicates whether compare-and-swap successfully performed the substitution. This indication may be achieved either with a simple Boolean response (this variant may often be referred to as compare-and-set) or by returning the value read from the memory location (not the value written to it).

As a practical working example, when a writer process is to write data into a current buffer, the writer process checks for the following: (1) Is the (pdb_id, objn, objd) stamped on the buffer different than that in the writer's UGA state? And (2) Is the buffer currently “locked”, e.g., is the version counter value odd? If the answer to both questions is NO, then the buffer is deemed safe for the writer process to use. The writer process may first increment the version counter value using CAS (e.g., to make the version counter value odd, i.e., locked), completes the write(s), and again increments the version counter value using CAS (to make the version counter value even, i.e., unlocked) in some embodiments.

In some embodiments, because the version counter is within a buffer (e.g., a buffer level counter), the version counter works when it is certain that the buffer has not been deallocated as part of an IGA shrink operation by a memory management coordinator process. In some embodiments, a different mechanism with the active writer counter may be used to ensure the presence of the buffer before using the version counter. In some other embodiments, an alternate approach is to maintain an IGA incarnation number that is incremented every time the IGA undergoes a growth or shrink operation. A writer process may cache this incarnation number in addition to the object and buffer details. While attempting to access the buffer, a writer process may check whether the incarnation number is unchanged before proceeding with the write(s).

Note that this can happen if a flusher proactively tries to flush the buffer even if it is not full, either due to manual PL/SQL procedure invocation or the buffer has not been modified for more than a threshold amount of time.

The buckets 102A in the IGA may be organized into a hash table format where each bucket or slot in the hash table corresponds to a bucket in the IGA, and the hash table (e.g., an IGA hash table) is stored in memory and maps a plurality of characteristics, attributes, etc. (e.g., table signatures of one or more database tables) to one or more flush statistics and/or one or more ingestion statistics. A bucket 102A or the plurality of buckets may correspond to a data structure having a plurality of fields for each bucket. For example, the data structure for a bucket may include a first field storing an active buffer counter 104A and a second field storing an active writer counter 106A.

An active buffer counter includes a bucket-level counter which indicates the total number of buffers that have pending writes to be flushed in some embodiments. An active buffer counter may be used for concurrency control between writer processes, the memory management coordinator, and flusher processes, etc. In some of these embodiments, when a writer process uses a buffer in a bucket, this active buffer counter value is atomically increased by 1 (or any other suitable value). On the other hand, when a buffer's contents are flushed to a table (e.g., a database table) or a persistent storage therefor, the active buffer counter value may be atomically decreased by 1 or any other suitable value. In some embodiments, a memory management coordinator may de-allocate a buffer if this count is zero (0), i.e., no writer is actively adding data to the buffer, nor are there any pending writes to be flushed to a table (e.g., a database table) or a persistent storage therefor.

An active writer counter 106A includes a bucket-level counter used for concurrency control between writer processors who may have cached buffer addresses and the memory management coordinator. In some embodiments, writer processes cache respective buffer addresses for performance reasons—caching buffer address(es) ensures that every writer need not go through the relatively more expensive process of obtaining a buffer for every write operation. Rather, for the duration of a writer process session, a writer process may request a free buffer once, cache the address of the buffer, and keep using the same buffer for subsequent writes until the buffer memory region (e.g., 1 MB contiguous memory space) is full.

A writer process may also use the active writer counter to determine whether the cached buffer needs to be invalidated in some embodiments. In these embodiments, a writer process may use compare-and-swap (CAS) on the bucket-level active writer counter to determine whether the cached buffer needs to be invalidated. More specifically, a writer process may check via CAS whether the active writer counter value is less than the number of buffers in the bucket plus one (“1”). If so, the buffer has not been shrunk, and the buffer is available for the writer process. In this case, the writer process increases the active writer counter value by one via CAS, writes data to the buffer, and then decrements the active writer counter value by one via CAS when the writer process finishes writing data to the buffer. In this example, the number of buffers plus one is used to indicate that a bucket has been designated for a shrink operation or deallocation.

In some rare cases where the bucket may have been deallocated as a part of an IGA shrink operation and reallocated again as a part of an IGA growth operation, these rare cases may create a false positive as if a buffer that was cached by a writer process is still available despite the fact that the actual buffer that was cached by the writer process has already been deallocated and then reallocated again. In these cases, a coarse IGA incarnation number or a fine-grained bucket incarnation number may be used to avoid such false positives.

An IGA shrink task may also check if the active writer counter value is zero via CAS. If the determination is affirmative (no active writers writing data to buffers in a bucket), the active writer counter value may be updated to the total number of buffers plus one (“1”) to indicate that the bucket is marked for deallocation. In these embodiments, if CAS succeeds then the IGA shrink task may free the buffers in the bucket. On the other hand, if either the active writer counter value is non-zero, or if CAS fails, then the IGA shrink task may wait (e.g., for a threshold amount of time) and retry or simply terminates this cycle.

In some embodiments, buffers are flushed only after they are full. However, to ensure that the lag between data being inserted into the IGA, and the data becoming visible to queries from the disk or storage segment, remains bounded, partially filled buffers may be flushed if the temporal duration since the last write exceeds a time threshold (e.g., 60 seconds). In these embodiments, it may be possible for a writer process session to have cached a buffer address that has since been flushed. With a static IGA, an odd-even counter per buffer may be used to prevent writers from reusing such flushed buffers. However, with a dynamic IGA, a buffer itself might be gone as part of an IGA shrink operation, and hence, relying on a location within the buffer header (such as the odd-even counter) may not necessarily work. Some embodiments solve this problem with the active writer counter that is maintained in a separate memory location outside the buffer (and hence an active writer counter is a bucket level counter, not a buffer level counter in some embodiments). The active writer counter may be maintained as an array, and this active writer counter tracks the state for every buffer in every hash bucket (also referred to as a bucket for simplicity).

In some embodiments, when a writer process writes data into a buffer, the writer process may use CAS (compare-and-swap) to bump this counter value by one (“1”), only if the count is less than the total number of buffers in the bucket plus one (“1”), which is used as a special value to indicate that the buffer represented by the counter has been or is to be de-allocated by the memory management coordinator. After a writer process finishes writing, the writer process may also use CAS to decrement this active writer counter (e.g., decrement by one (“1”)). The memory management process may de-allocate a buffer if the active writer counter value is zero (“0”) in some embodiments. When it discovers the active writer counter value as zero (“0”), the memory management coordinator may perform compare-and-swap with the special value of the total number of buffers in the bucket plus one (“1”) before the memory management coordinator finishes the buffer deallocation, which prevents other writers from sneaking in and writing data to the buffer. The bucket (or hash table bucket maintained for the buffers in the IGA) 102A may also comprise one or more other fields storing respective values in some of these embodiments.

FIG. 1C illustrates a high-level block diagram for a method or system for adaptive memory management for data ingestion and flush according to some embodiments of the present disclosure. In these embodiments, A memory area of a global memory of a computing system may be identified at 100. In these embodiments, the memory area comprises one or more buffer memory areas and is allocated for ingesting data for a database. In some of these embodiments, the memory area identified at 100 comprises an IGA. In some embodiments, the memory area includes one or more granules each of which is a contiguous block of memory and comprises one or more buckets while a bucket includes one or more buffers (or buffer memory area). A persistent device into which data or information stored in the memory area is to be flushed may be identified at 101.

In some embodiments, a predicted ingest rate and a predicted flush rate for a memory area (e.g., an ingest global area (IGA)) for a database may be determined at 102 for a database. More details about determining a predicted ingest rate and determining a predicted flush rate will be described below with reference to various drawing figures. A memory management task may be determined at 104 for the IGA based at least in part upon the predicted ingest rate and the predicted flush rate. A memory management task may be performed or invoked by, for example, a memory management coordinator process or service in some embodiments and may include, for example, an IGA growth task that increases the allocation size of the IGA or an IGA shrink operation that decreases the allocation size of the IGA. More details about determining a memory management task will be described below with reference to various drawing figures.

A buffer accessibility map (which may also be referred to as a bucket mask in the present disclosure) may be modified at 106 based at least in part upon the memory management task determined at 104. A buffer accessibility map or bucket mask includes a data structure storing therein data that indicates whether a bucket or one or more buffers in the bucket are available or unavailable. In some embodiments where the memory management task (e.g., an IGA growth task) is to increase the allocation size of the IGA, the bucket mask may be modified to expand or increase the range of buckets to accommodate the additional bucket(s) that is (are) made available by the memory management task. In some embodiments where the memory management task (e.g., an IGA shrink task) is to decrease the allocation size of the IGA, the bucket mask may be modified to reduce or decrease the active range of buckets to indicate the deallocation of the bucket(s) that is (are) deallocated by the memory management task. In some embodiments, the bucket mask may be modified before the execution of the memory management task determined at 104 while in some other embodiments, the bucket mask may be modified after the execution of the memory management task determined at 104. More details about modifying a bucket mask based on a memory management task will be described below with reference to various drawing figures. It shall be noted that the terms “buffer accessibility map” and “bucket mask” may be used interchangeably throughout the present disclosure.

The IGA may then be adaptively resized at 108 into a resized IGA at least by executing the memory management task. In various embodiments, a memory management coordinator (e.g., a process or a service) may execute the memory management task to grow or shrink the IGA. Because the memory management task is determined based at least in part upon the predicted ingest rate and the predicted flush rate, the memory management coordinator thus adaptively resizes the IGA by executing or invoking the execution of the memory management task, and the adaptive resizing is thus based at least in part upon the predicted ingest rate and the predicted flush rate. More details about adaptively resizing the IGA will be described below with reference to various drawing figures.

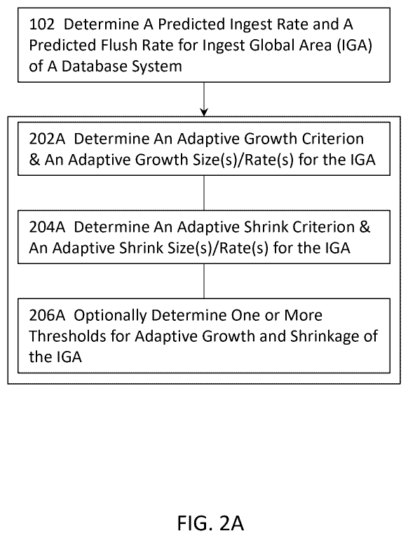

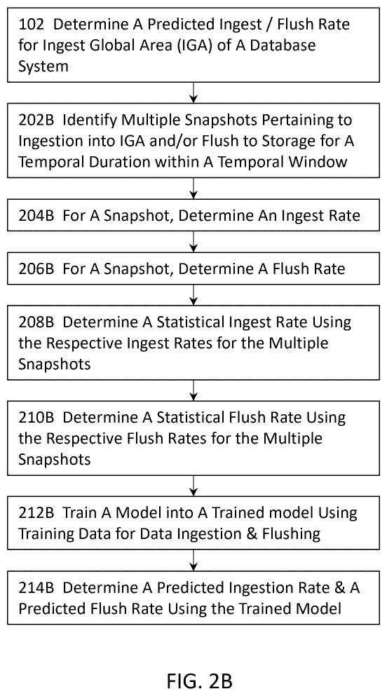

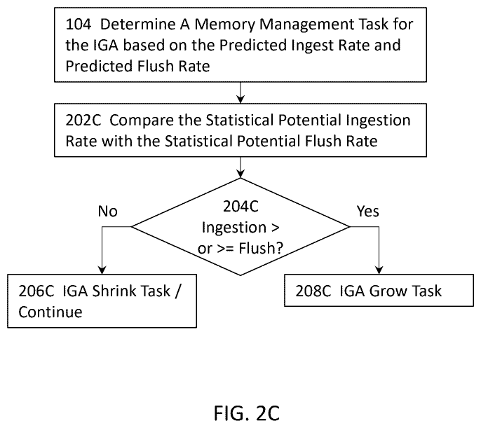

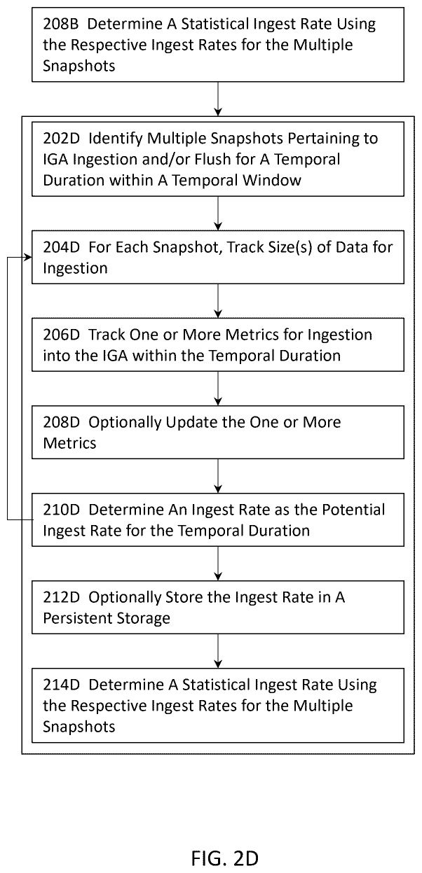

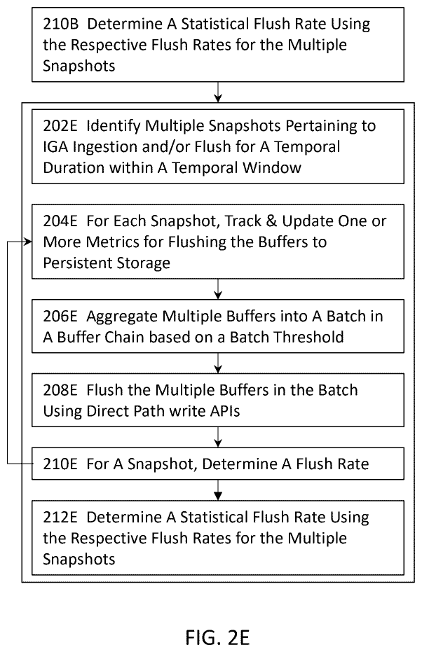

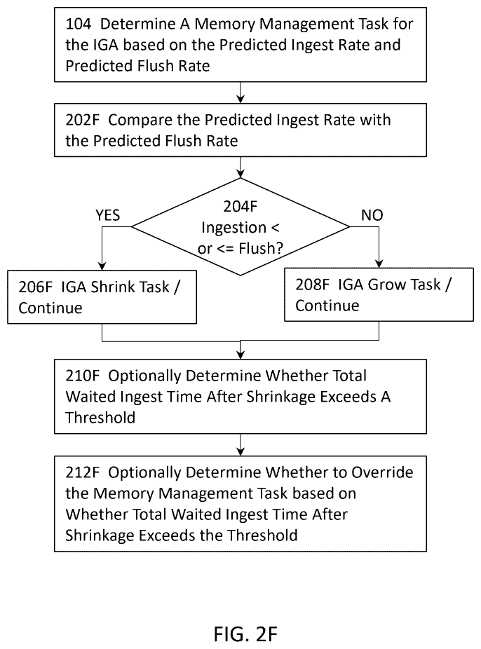

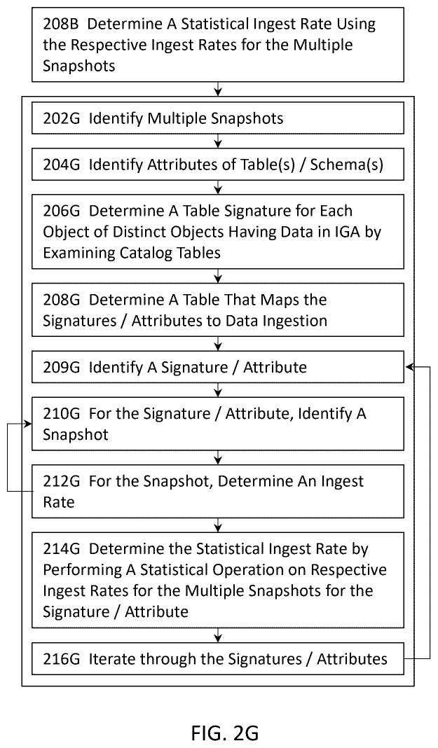

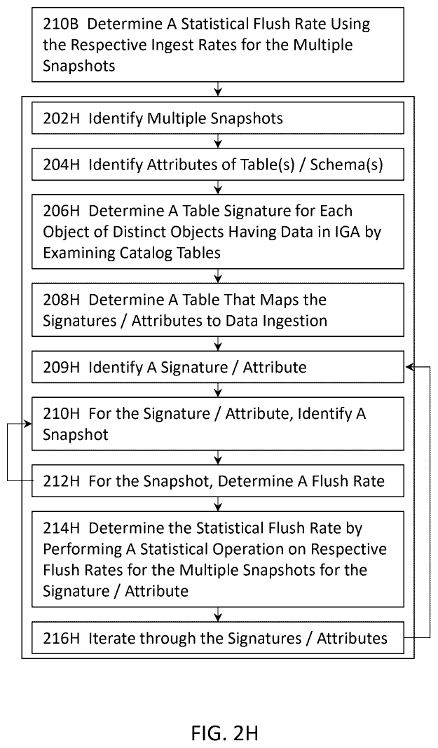

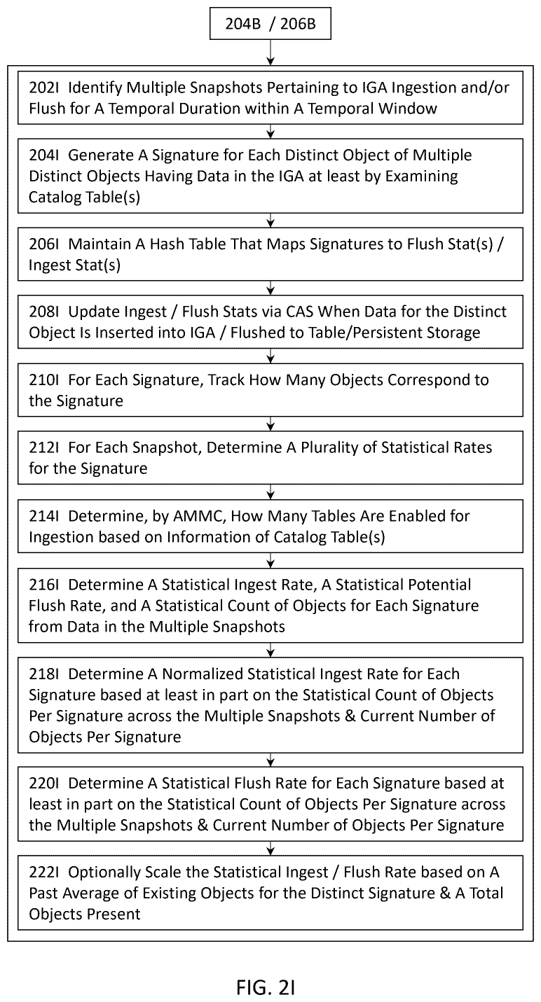

FIG. 2A shows more details about a portion of the high-level block diagram illustrated in FIG. 1C in some embodiments. More particularly, FIG. 2A illustrates more details about determining a predicted ingest rate and a predicted shrink rate at 102 of FIG. 1C in some embodiments. In these embodiments illustrated in FIG. 2A, an adaptive growth criterion and an adaptive growth size or growth rate may be determined at 202A for the IGA. In some embodiments, rather than specifying a utilization percentage or growth percentage, a utilization size (e.g., the amount of IGA memory space utilized) and/or a growth size (e.g., the amount of memory space to grow the IGA by) may be determined at 202A.

In some embodiments, an adaptive growth criterion may comprise the criterion of _iga_adaptive_growth_load_percent=75 which triggers an IGA growth task when the IGA utilization rate is greater than or greater than or equal to 75% or any other desired or required threshold utilization rate. In some embodiments, an adaptive growth size or rate for an IGA may include the criterion of _iga_adaptive_growth_percent=25 which indicates to grow the IGA by 25% of the current allocation size of the IGA although other suitable, required, or desired size or rate may also be used. In some embodiments, rather than specifying a utilization percentage or growth percentage, a utilization size (e.g., the amount of IGA memory space utilized) and/or a growth size (e.g., the amount of memory space to grow the IGA by) may be determined at 202A.

In these embodiments illustrated in FIG. 2A, an adaptive shrink criterion and an adaptive shrink size or rate may be determined at 204A for the IGA. In some embodiments, an adaptive shrink criterion may comprise the criterion of _iga_adaptive_shrink_load_percent=50 which triggers the IGA shrink operation to reduce the IGA allocation size when the utilization of the current IGA drops to or below 50% (or any other suitable, desired, or required utilization). An adaptive shrink size or rate may comprise the criterion of _iga_adaptive_shrink_percent=5 which triggers the IGA shrink operation to reduce the IGA allocation size by 5% or any other suitable, desired, or required percentage. In some embodiments, rather than specifying a utilization percentage or shrink percentage, a utilization size (e.g., the amount of IGA memory space utilized) and/or a shrink size (e.g., the amount of memory space to reduce the IGA by) may be determined at 204A.

One or more thresholds for the adaptive growth and/or shrinkage of the IGA may be optionally determined at 206A in some embodiments. For example, the maximum size of the IGA (e.g., to limit IGA growth operations) may be optionally imposed by using the expression (_iga_adaptive_max_size). In addition or in the alternative, the minimum size (e.g., to limit IGA shrink operations) may be optionally imposed by using the expression (_iga_adaptive_min_size) in these embodiments.

FIG. 2B shows more details about a portion of the high-level block diagram illustrated in FIG. 1C in some embodiments. More particularly, FIG. 2B illustrates more details about determining a predicted ingest rate and a predicted shrink rate at 102 of FIG. 1C in some embodiments. In these embodiments, multiple snapshots pertaining to data ingestion into the IGA and/or flush IGA data to a table (e.g., a database table) or persistent storage therefor may be identified at 202B. A snapshot may correspond to a temporal duration within a temporal window. For example, a snapshot of a database or persistent storage therefor may be captured for a ten-minute period within a two-hour temporal window in some of these embodiments. Atemporal window may be fixed in length and time in some embodiments or moving or variable in length and/or time in some other embodiments.

For a snapshot of the multiple snapshots identified at 202B, an ingest rate may be determined for the snapshot at 204B by, for example, dividing the amount of data ingested by the temporal duration. In some embodiments, a flush rate for the temporal duration may be determined for the snapshot at 206B by, for example, dividing the amount of data flushed to the table (e.g., a database table) or the persistent storage therefor by the temporal duration.

With the ingest rates determined for at least some of the multiple snapshots at 204B, a statistical ingest rate may be determined at 208B using the respective ingest rates for the at least some of the multiple snapshots. In some embodiments, the statistical ingest rate may be determined at 208B using the following process:

$${\sum }_{snap = 1}^{n} {w}_{snap} {ir}_{snap}$$

$${\sum }_{snap = 1}^{n} {w}_{snap} = 1 , {w}_{snap} ∈ [ 0 , 1 ]$$

Where:
irₛₙₐₚ=average rate of potential insert or ingestion in MB/s for a snapshot,
wₛₙₐₚ=weight assigned to the snapshot.

In some embodiments, the statistical flush rate may be determined at 210B using the following process:

$${\sum }_{snap = 1}^{n} {w}_{snap} {fr}_{snap}$$

$${\sum }_{snap = 1}^{n} {w}_{snap} = 1 , {w}_{snap} ∈ [ 0 , 1 ]$$

Where:
frₛₙₐₚ=average rate of potential flush in MB/s for a snapshot;
wₛₙₐₚ=weight assigned to the snapshot.

With the statistical ingestion rate and the statistical flush rate determined, a model may be trained into a trained model at 212B using training data for data ingestion and data flushing. For example, data pertaining to or in the aforementioned snapshots captured during the respective temporal duration within the temporal period for data ingestion and data flush may be divided into a training dataset, and at least some of the remaining data may be used as a validation dataset in some embodiments. The training dataset may be used to train the model (e.g., training the model's model parameters such as the respective weights or the kernel of the model and/or hyperparameters such as learning rate, a total number of hidden layers, etc.) into a trained model so that the trained model better fits or approximates the training dataset (e.g., with errors or deviations within a threshold criterion), and the validation dataset may then be used to determine an estimate of the model skill (e.g., an unbiased evaluation of the model fit on the training dataset while tuning one or more hyperparameters) of the trained model.

In some embodiments, a model may be trained into a plurality of trained models each having a respective set of parameters and/or hyperparameters. A validation dataset may then determine a respective estimate of each trained model and compare the respective estimates of the plurality of trained models for determining a final trained model. In some embodiments where the skill(s) on the validation dataset becomes more and more incorporated into the configuration of the model, the validation or evaluation with the validation dataset becomes more biased. In these embodiments, the remaining data pertaining to or in the aforementioned snapshots may further include a test dataset which may be used to provide an unbiased evaluation of a final model fit on the training dataset.

With the model trained into a final, trained model, a predicted IGA ingestion rate and a predicted IGA flush rate may then be determined at 214B using the final, trained model. In some embodiments as the final, trained model is deployed to predict ingestion and flush rates used in determining memory management tasks (e.g., IGA growth tasks, IGA shrink tasks, etc.), the final, trained model using data (e.g., additional snapshots) captured after the final, trained model is determined. In these embodiments illustrated in FIG. 2B and described above, two estimates (average ingestion rate “irₛₙₐₚ” and average flush “frₛₙₐₚ” rate for the temporal duration) are determined or each snapshot.

FIG. 2C shows more details about a portion of the high-level block diagram illustrated in FIG. 1C in some embodiments. More specifically, FIG. 2C illustrates more details about determining a memory management task for the IGA at 104 of FIG. 1C. In these embodiments illustrated in FIG. 2C, the statistical predicted or potential ingestion rate determined at, for example, 208B in FIG. 2B may be compared to or with the statistical predicted or potential flush rate determined at, for example, 210B in FIG. 2B at 202C. At 204C, a determination may be made to decide whether the statistical predicted or potential ingestion rate is greater than or greater than or equal to the statistical predicted or potential flush rate.

When it is determined at 204C that the predicted or statistical potential ingestion rate is greater than the predicted or statistical potential flush rate (or when the predicted or statistical potential ingestion rate is greater than or equal to the predicted or statistical potential flush rate), an IGA growth memory management task may be determined at 208C. On the other hand, When it is determined 204C that the predicted or statistical potential ingestion rate is not greater than or greater than or equal to the predicted or statistical potential flush rate, an IGA shrink memory management task may be determined at 206C. In some embodiments, rather than compare sheer values of the predicted or statistical potential ingestion rate and the predicted or statistical potential flush rate, a margin or threshold may be imposed.

For example, an IGA growth task may be determined at 216B when the predicted or statistical potential ingestion rate is greater than (or equal to) the predicted or statistical potential flush rate beyond a margin (e.g., 10% or a fixed value in MB/second). Similarly, an IGA shrink task may be determined at 218B when the predicted or statistical potential ingestion rate is smaller than (or equal to) the predicted or statistical potential flush rate beyond a margin (e.g., 5% or a fixed value in MB/second). In some embodiments, the margin or threshold for IGA shrink tasks may be more conservative than that for IGA growth tasks. In some other embodiments, the margin or threshold for IGA shrink tasks may be more aggressive than that for IGA growth tasks.

FIG. 2D shows more details about a portion of the block diagram illustrated in FIG. 2B in some embodiments. More specifically, FIG. 2D illustrates more details about determining a predicted or statistical ingestion rate at 208B of FIG. 2B. In these embodiments, multiple snapshots pertaining to IGA ingestion for a temporal duration within a temporal window may be determined at 202D. For each snapshot of the multiple snapshots identified at 202D, the method or system described herein may track one or more characteristics pertaining to the data for ingestion into the IGA at 204D. Some examples of the one or more characteristics may comprise the size(s) of data ingested into the IGA, the instantaneous rate(s) at which data is ingested into the IGA, or the average rate(s) at which data is ingested into the IGA, or any other suitable, desired, or required characteristics.

The method or system may further track one or more metrics for data ingestion into the IGA within the temporal duration at 206D. For example, the average or instantaneous potential rate of insert or ingestion into the IGA, the average or instantaneous potential flush rate from the IGA to the table (e.g., a database table) or the persistent storage therefor, the comparison between the average or instantaneous potential ingestion rate and the average or instantaneous potential flush rate, etc. may be tracked at 206D.

In some embodiments, the size of the data to be inserted by a foreground process (e.g., a data ingestion process) may be tracked at 206D. In addition or in the alternative, the time taken (e.g., the time taken on the server side) to insert the data with a foreground process to the IGA may be tracked in some embodiments. In some of these embodiments, the amount of time spent on waiting for an available buffer for data ingestion with a foreground process may be tracked at 206D.

Other metrics such as the total size of data for ingestion (“total_insert_data_in_snapshot” in MB/second or other suitable units of measure), total data ingestion time in a snapshot (e.g., “total_insert_time_in_snapshot” in seconds or other suitable units of measure), and/or total ingestion time waited (e.g., “total_insert_time_waited_in_snapshot” in seconds or other suitable units of measure), or any other suitable, desired, or required metrics may be tracked at 206D. The one or more metrics may be optionally updated at 208D in some embodiments. For example, a data structure may be maintained to store one or more metrics for each snapshot of the plurality of snapshots captured by using the snapshot identifier as the row index of the data structure and storing the one or more metrics for each snapshot identifier in one or more corresponding columns. It shall be noted that other arrangement between the snapshot and its one or more metrics in the data structure may also be used in other embodiments.

An ingest rate may be determined as the potential ingest rate for the temporal duration at 210D based at least in part upon the size of the data for ingestion tracked at 204D and/or the one or more metrics tracked at 206D in some embodiments. The potential ingest rate is determined at 210D for the snapshot identified at 204D, and the process may return to 204D to identify a separate snapshot and repeat 204D through 210D in an identical or substantially similar manner described above. In some of these embodiments illustrated in FIG. 2D, the potential ingest rate determined at 210D may be optionally stored at 212D in a table (e.g., a database table) or a persistent storage therefor. In some embodiments, the potential ingest rate determined for a snapshot may be stored at 212D into a data structure that is organized to store one or more pieces of information (e.g., the potential ingest rate, one or more metrics related to the potential ingest rate, time stamp or temporal information for the snapshot, etc.) for each snapshot. The data structure may include a key structure (e.g., a key column) that may use a unique key to identify a particular snapshot so that the data structure may be queried with, for example, structured query language statements.

A statistical ingest rate may be determined at 214D using the respective potential ingest rates for the multiple snapshots identified at 202D. In some embodiments, a respective weight or multiplier may be determined and/or learned (e.g., using machine learning techniques) for each snapshot of the multiple snapshots so that the statistical ingest rate may be determined as the weighted sum of the products of the multiple potential ingest rates for the corresponding snapshots and their respective weights or multipliers. In some embodiments, the statistical ingest rate may be determined at 208B using the following process:

$${\sum }_{snap = 1}^{n} {w}_{snap} {ir}_{snap}$$

$${\sum }_{snap = 1}^{n} {w}_{snap} = 1 , {w}_{snap} ∈ [ 0 , 1 ]$$

Where:
irₛₙₐₚ=average rate of potential insert or ingestion in MB/s for a snapshot;
wₛₙₐₚ=weight assigned to the snapshot.

In some embodiments, the statistical ingest rate may be stored in a data structure that correlates the statistical ingest rate with, for example, at least one of a snapshot identifier of the snapshot for which the statistical ingest rate is determined, the time window for the aforementioned snapshot, an instance identifier, the intermediate potential rate(s) of ingestion, the intermediate potential flush rate(s), or the statistical flush rate (described below with reference to FIG. 2E), or any other suitable attributes or characteristics.

FIG. 2E shows more details about a portion of the block diagram illustrated in FIG. 2B in some embodiments. More specifically, FIG. 2E illustrates more details about determining a statistical flush rate at 210B of FIG. 2B. In these embodiments, multiple snapshots pertaining to IGA flush for a temporal duration within a temporal window may be determined at 202E. For each snapshot of the multiple snapshots identified at 202E, the method or system described herein may track and/or update one or more metrics pertaining to flushing the data in the IGA to a table (e.g., a database table) or a persistent storage therefor at 204E. Some examples of the one or more metrics may comprise the size(s) of data flushed from the IGA to the table (e.g., a database table) or a persistent storage therefor, the instantaneous rate(s) at which data is flushed from the IGA to the table (e.g., a database table) or a persistent storage therefor, or the average rate(s) at which data is flushed from the IGA to the table (e.g., a database table) or a persistent storage therefor, elapsed time for flushing each batch, the number of rows flushed, the total flushed data for a snapshot, the total flush time for a snapshot, or the total time waited for flushing data for a snapshot, or any other suitable, desired, or required characteristics.

Other examples of the one or more metrics may include, without limitation, the average or instantaneous potential flush rate from the IGA to a table (e.g., a database table) or a persistent storage therefor, the average or instantaneous potential flush rate from the IGA to the table (e.g., a database table) or a persistent storage therefor, the comparison between the average or instantaneous potential ingestion rate and the average or instantaneous potential flush rate, the time taken (e.g., the time taken on the server side) to flush the data with a background process from the IGA to the table (e.g., a database table) or the persistent storage therefor, or the amount of time spent on waiting for flushing data from the IGA to the table (e.g., a database table) or the persistent storage therefor with a background process, or any other suitable, required, or desired metrics.

Other metrics such as the total size of data for flush (“total_flush_olata_for_signature_in_snapshot” in MB/second or other suitable units of measure), total data flush time for a signature pertaining to a snapshot (e.g., “total_flush_time_for_signature_in_snapshot” in seconds or other suitable units of measure), or any other suitable, desired, or required metrics may be tracked and/or updated at 204E. For example, a data structure may be maintained to store one or more metrics for each snapshot of the plurality of snapshots captured by using the snapshot identifier as the row index of the data structure and storing the one or more metrics for each snapshot identifier in one or more corresponding columns. It shall be noted that other arrangement between the snapshot and its one or more metrics in the data structure may also be used in other embodiments.

Multiple buffers may be aggregated at 206E into a batch in a buffer chain based at least in part upon a batch threshold. For example, a batch of 255 rows (or the maximum number of rows in the buffer or any other batch threshold) may be flushed as a batch using direct path write APIs (e.g., kddir). A buffer chain may include a write chain or a flush chain in some embodiments although in the context of flushing data from IGA to the table (e.g., a database table) or the persistent storage therefor, a background flush process is primarily concerned with a flush chain. A flush chain may be converted from a write chain in some embodiments. Aflush chain includes a plurality of buffers that are to be or being flushed by one or more background processes (e.g., one or more flush processes) to the table (e.g., a database table) or the persistent storage therefor. A write chain, on the other hand, is created and/or updated by a writer process that writes data into a buffer and, when the buffer becomes full, adds the buffer to a list that is referred to herein as a write chain in some embodiments. This write chain comprises buffers that need to be flushed for a specific segment and a specific session.

Therefore, a write chain comprises buffers that need to be flushed. In some embodiments, a write chain includes one or more buffers that are written into by a writer process and need to be flushed because these one or more buffers are full or because a temporal limit (e.g., flush once every X seconds or minutes). In some other embodiments, a write chain includes one or more buffers that are written into by a plurality of writer processes in separate sessions (and separate threads of execution) and need to be flushed to the table (e.g., a database table) or the persistent storage therefor either because these one or more buffers are full or because a temporal limit (e.g., flush once every X seconds or minutes).

Write chains may be converted to flush chains by one or more background flush processes in some embodiments. In some embodiments, once a write chain is converted to a flush chain, no new full buffers may be added to the write chain, and any writers that have added buffer(s) to the write chain may start a new write chain. That is, once a write chain is converted into a flush chain, the write chain is “locked” to prevent writer processes to add more buffers to the write chain.

The multiple buffers in the batch may be flushed at 208E. In some embodiments, these multiple buffers in the batch may be flushed by using one or more direct path write APIs (application programming interface(s)). A direct path API comprises the mechanism that enables two-way communication between software applications driven by requests by appending rows to the end of a table for faster bulk insertion and may be accessed through, for example, the /*+ append */ hint.

In some embodiments, direct path writes allow a session to queue an I/O (input/output) write request and continue processing while the OS (operating system) handles the I/O (input/output). If the session needs to know whether an outstanding write is complete, then it waits for this wait event. This may happen because the session is either out of free slots and needs an empty buffer (it waits on the oldest 1/O), or it needs to ensure all writes are flushed. In some embodiments where asynchronous I/O is not being used, then the I/O write request blocks until it is completed, but this does not show as a wait at the time the I/O is issued. In these embodiments, the session returns later to pick up the completed I/O data but may then show a wait on “direct path write” even though this wait will return immediately.

A potential flush rate may be determined as the potential flush rate for the temporal duration at 210E based at least in part upon the one or more metrics tracked at 204E in some embodiments. The potential ingest rate is determined at 210E for the snapshot identified at 204E, and the process may return to 204E to identify a separate snapshot and repeat 204E through 210E in an identical or substantially similar manner described above. In some of these embodiments illustrated in FIG. 2E, the potential flush rate determined at 210E may be optionally stored in a persistent storage. In some embodiments, the potential flush rate determined for a snapshot may be stored into a data structure (e.g., in the same structure storing the potential ingest rates described above with reference to FIG. 2D in some embodiments or in a separate data structure in some other embodiments) that is organized to store one or more pieces of information (e.g., the potential flush rate, one or more metrics related to the potential flush rate, time stamp or temporal information for the snapshot, etc.) for each snapshot. The data structure may include a key structure (e.g., a key column) that may use a unique key to identify a particular snapshot so that the data structure may be queried with, for example, structured query language statements.

A statistical flush rate may be determined at 212E using the respective potential flush rates for the multiple snapshots identified at 202E. In some embodiments, a respective weight or multiplier may be determined and/or learned (e.g., using machine learning techniques) for each snapshot of the multiple snapshots so that the statistical flush rate may be determined as the weighted sum of the products of the multiple potential flush rates for the corresponding snapshots and their respective weights or multipliers. In some embodiments, the statistical flush rate may be determined at 212E using the following process:

$${\sum }_{snap = 1}^{n} {w}_{snap} {fr}_{snap}$$

$${\sum }_{snap = 1}^{n} {w}_{snap} = 1 , {w}_{snap} ∈ [ 0 , 1 ]$$

Where:
frₛₙₐₚ=average rate of potential flush in MB/s for a snapshot;
wₛₙₐₚ=weight assigned to the snapshot.

In the embodiments described above with reference to FIG. 2E, two measures are determined for a snapshot—a potential ingest rate and a potential flush rate—for a temporal duration within a temporal window. In some embodiments, the statistical flush rate may be stored in a data structure that correlates the statistical flush rate with, for example, at least one of a snapshot identifier of the snapshot for which the statistical flush rate is determined, the time window for the aforementioned snapshot, an instance identifier of the database instance, the intermediate potential rate(s) of ingestion, the intermediate potential flush rate(s), or the statistical ingest rate (described above with reference to FIG. 2D), or any other suitable attributes or characteristics.

FIG. 2F shows more details about a portion of the high-level block diagram illustrated in FIG. 1C in some embodiments. More particularly, FIG. 2F illustrates more details about determining a memory management task for the IGA described above at 104 of FIG. 1C. In these embodiments, the predicted ingest rate may be compared to or with the predicted flush rate at 202F. If it is determined at 204F that the predicted ingest rate is determined to be smaller than (or smaller than or equal to) the predicted flush rate, an IGA shrink task may be determined to reduce the allocation and size of the current IGA at 206F.

On the other hand, if it is determined at 204F that the predicted ingest rate is determined not to be smaller than (or not smaller than or equal to) the predicted flush rate, an IGA growth task may be determined to increase the allocation and size of the current IGA at 208F. In some other embodiments, rather than comparing the sheer values of the predicted ingest rate and the predicted flush rate, one or more margins or thresholds may be imposed in the determination at 204F. For example, an IGA growth task may be determined at 208F when the potential ingest rate is determined not to be smaller than the potential flush rate plus a margin or threshold (e.g., the potential ingest rate is greater than the potential flush rate by 10% or a fixed rate value). Similarly, an IGA shrink task may be determined at 206F when the potential ingest rate is determined to be smaller than the potential flush rate plus a margin or threshold (e.g., the potential ingest rate is smaller than the potential flush rate by 5% or a fixed rate value).

In some embodiments where the potential ingest rate is determined not to be smaller than (or smaller than or equal to) the potential flush rate, the process may continue at 208F without initiating or invoking an IGA growth task. For example, the process may continue at 208F without initiating or invoking an IGA growth task when it is determined that the potential ingest rate is greater than the potential flush rate, yet the difference does not exceed a margin or threshold. Similarly, the process may continue at 206F without initiating or invoking an IGA shrink task when it is determined that the potential ingest rate is smaller the potential flush rate, yet the difference does not exceed a margin or threshold.

In some embodiments, an optional determination may be made at 210F to determine whether the total waited ingest time exceeds a threshold (e.g., the metric “total_insert_time_waited_in_snapshot” for each of a plurality of snapshots or the summation of the aforementioned waited time for the plurality of snapshots exceeds a configurable threshold). In these embodiments, a separate determination (e.g., by a memory management coordinator process or service described above) may be optionally made to decide whether to override the memory management task optionally determined at 210F, based at least in part upon whether the total waited ingest time after shrinkage of the IGA exceeds a threshold waited time.

FIG. 2G shows more details about a portion of the block diagram illustrated in FIG. 2B in some embodiments. More specifically, FIG. 2G illustrates more details about determining a statistical ingest rate at 208B of FIG. 2B. These embodiments compare and contrast with those described above with reference to FIG. 2D in that these embodiments estimate IGA activities (e.g., ingestion and flush) while being made aware of the schema and/or table(s). In these embodiments illustrated in FIG. 2G, multiple snapshots may be identified at 202G. For example, a snapshot may be captured for a 10-minute temporal duration within a two-hour moving temporal window. In some embodiments, a respective weight or multiplier may be optionally identified at 202G for each snapshot. These weights or multipliers may be the targets of training of a predictive model as the model parameters by using a training dataset with machine learning techniques described herein.

Multiple attributes of or pertaining to one or more tables and/or one or more schemas may be identified at 204G. A signature of a table (e.g., a database table) or a schema thereof may include a pattern of a plurality of bits each of which indicates the presence or absence of a corresponding attribute. Unlike the embodiments illustrated in FIG. 2D and described above, these embodiments illustrated in FIG. 2G account for finer granularity of the table(s) and/or schema(s) pertaining to the database(s) for which various types of data are ingested into the IGA and flushed from the IGA to the table (e.g., a database table) or the persistent storage therefor.

These multiple attributes may include at least one of the row data size(s) such as narrower rows and wider rows (e.g., the row size greater than 8 KB, or the number of columns greater than 255, etc.), compression of a table or one or more segments thereof, whether a table is indexed, whether the index is compressed, whether the data and/or index of a table is encrypted, transparent data encryption, one or more constraints on a table, or types of data in a table, or any other suitable, desired, or required attributes of or pertaining to a table or schema of a database for which data from various sources (e.g., IoT sources) is ingested into the IGA and flushed to the table (e.g., a database table) or the persistent storage therefor. In some embodiments, an attribute may be expanded into multiple attributes to create at least one additional finer-grained table attribute. For example, an index attribute having a binary index value (e.g., Y or N) may be expanded into a set of histogram-like buckets for a number of regular indices between a first value (e.g., 1 or 10) and a second value (e.g., 10 or 20).

In some embodiments, determining a statistical ingest rate may account for the row data size(s) of a database. Some databases may chain rows that may include more than, for example, 255 columns or may be too wide to fit within the available space inside a data block. A chained row may consume more cycles to insert when compared to a row that fits within a single data block in some embodiments. For example, a chained row may require searching for available space across multiple data blocks to fit the various row pieces. Insertion of a new row piece may require occupying, for example, an interested transaction list (ITL) entry, maintaining the slot directory within the block, or any other attributes, characteristics, properties, etc. that may require time for completion.

In some embodiments, determining a statistical ingest rate may account for one or more attributes pertaining to compression of a table or one or more segments thereof. A table or one or more segments thereof (e.g., partitions, sub-partitions etc.) may be compressed with a wide variety of compression algorithms in some embodiments. In some of these embodiments, algorithms such as advanced row compression may perform in-line compression of data as it is getting inserted which can add overheads in the flush path. In some other embodiments, other algorithms such as Hybrid Columnar Compression (HCC) Compression (Query LOW/HIGH, Archive LOW/HIGH that cause a database to store the same column for a group of rows together to increase the storage savings achieved from compression) add single row inserts into an uncompressed set of blocks but may pack array inserts into HCC CUs (compression units).

In some embodiments, creating a columnar compressed unit may involve encoding the data using techniques such as Huffman encoding, delta encoding, run length encoding, or any other suitable algorithms, etc. Some embodiments may apply a bit-compression algorithm such as ZSTD (ZStandard), ZLIB (ZLibrary), etc. and finally fit a serialized image of the CU (compression unit) as a row with pieces chained across many data blocks. Ingesting data into a table or one or more segments thereof may require more compute resource and consume more time. Some embodiments thus account for one or more attributes pertaining to compression of table(s) or one or more segments thereof in determining a statistical ingest rate. In these embodiments, ingesting data into the IGA and/or flushing data from the IGA into a compressed segment may take significantly longer than ingesting data into uncompressed segment or flushing data into an uncompressed segment depending on the data compression level.

In some embodiments, determining a statistical ingest rate may account for one or more attributes pertaining to whether a table is indexed. In these embodiments, data ingestion may defer maintenance of indexes on the table until, for example, the data is flushed to an on-disk segment. Some databases support a variety of indices, such as regular B-tree indices, function-based B-tree indices involving expressions on relational columns, or on scalar fields within a JSON (JavaScript Object Notation) document, bitmap indices, or custom domain indices, or any other suitable indices, etc. In some embodiments with partitioned tables, indices may be local to the partition or global for the entire table. In addition or in the alternative, an index may be a single-column or multi-column index. In some embodiments, the maintenance overheads for each of these index types may be vastly different, and may be affected by, for example, the size of indexed columns, cardinality of indexed columns, complexity of the expression computation, or other pertinent factors, etc. For example, computing a relational expression such as upper(name) is far cheaper than extracting a field from a JSON document such as JSON_VALUE (customer, ‘$.address.zip’). In these embodiments, the cost of flushing data from the IGA into a table segment may thus vary, depending on a myriad of one or more index attributes. In these embodiments, ingesting data into the IGA and/or flushing data from the IGA to a table (e.g., a database table) or a persistent storage therefor may take longer due to one or more attributes pertaining to indices, and these embodiments account for one or more such one or more attributes.

In some embodiments, determining a statistical ingest rate may account for one or more attributes pertaining to whether the index is compressed. In these embodiments, indices may be compressed. Algorithms for index compression may include, for example, a static inter-column PREFIX compression, an adaptive inter-column prefix compression (ADVANCED LOW), a complex suite of multiple compression algorithms (ADVANCED HIGH), or other suitable algorithms. Algorithms such as inter-column prefix compression (such as PREFIX and ADVANCED LOW) may be light-weight and often add reduced or even minimal overhead over uncompressed index maintenance in some embodiments. On the other hand, when index leaf blocks are split or merged, a fresh computation for the new optimal prefix column count, which may be quite expensive, may be performed. ADVANCED HIGH algorithms are much more involved, comprising techniques such as intra-column prefix compression, suffix compression, constant length compression, row directory compression, rowid bitmap encoding, etc., which often add significant overhead in index maintenance. In these embodiments, index compression may play a more significant role in determining a flush rate from the IGA into a table or a segment thereof, and these embodiments account for one or more attributes pertaining to such indices.

In some embodiments, determining a statistical ingest rate may account for one or more attributes pertaining to transparent data encryption. Like table compression, encrypting table and/or index data often adds overhead to the insert pipeline. Further, different algorithms may have varying performance characteristics such as ARIA (a general-purpose block cipher algorithm) and GOST block cypher (Magma) that are slower than AES. In these embodiments, data and index encryption may play a role in determining a flush rate from the IGA into a table or a segment thereof, and these embodiments account for one or more attributes pertaining to data and/or index encryption.

In some embodiments, determining a statistical ingest rate may account for one or more constraints on a table. Constraints such as uniqueness, referential integrity, check, etc. are all enforced when the data is flushed to the disk segment from the IGA. Validating constraints may be somewhat expensive depending at least in part on the table size and/or the complexity of the constraint. In these embodiments, constraints may play a role in determining a flush rate from the IGA into a table or a segment thereof, and these embodiments account for one or more attributes pertaining to such one or more constraints.

In some embodiments, determining a statistical ingest rate may account for types of data in a table. In these embodiments, inserting data into certain types of table columns such as BLOB (binary large object), CLOB (character large object), XML (Extensible Markup Language), JSON etc. are more expensive that inserting data into comparable size varchar columns. Some of these embodiments apply to in-lined LOB (large object) columns because often this involves constructing a LOB RCI header. Further, usage of LOB features such as secure files, deduplication, and LOB Compression may add even larger overheads to the flush pipeline because data now may be transformed prior to ingestion.

In the embodiments illustrated in FIG. 2D, tracking one average rate of flush across a diverse set of table signatures may lose vital information and my likely yield sub-optimal predictions for IGA growth and/or shrink. The embodiments illustrated in FIG. 2G aim to categorize the flush rate for each key table signature as determined by the set of attributes described above and use it to predict the flush rate more accurately. In some embodiments illustrated FIG. 2G, the aforementioned list of attributes is illustrative but not exhaustive, and a plethora of other schema or table attributes that may also influence performance.

A table signature may be determined at 206G by examining one or more catalog tables for an object of a plurality of objects having data in the IGA in some embodiments. In some of these embodiments, the plurality of objects is distinct from one another so that each object constitutes a distinct object. In some embodiments, a catalog table comprises a table that returns information about another table, or data source. In these embodiments where a computing system has one or more clusters, and a database server may be a cluster of the one or more clusters. A cluster may thus include one or more catalogs where a catalog may include one or more databases.

In some embodiments, a catalog (e.g., a database) may have one or schemas where a schema comprises the namespace of tables, and even the security boundary in some of these embodiments. These embodiments thus track the distinct objects or the total number thereof for which a table signature is generated or determined at 206G. Compared to the embodiments illustrated in FIG. 2D, these embodiments illustrated in FIG. 2G maintain an array of averages for each table signature for a given snapshot of the multiple snapshots identified at 202G.

A table (e.g., a has table) may be identified or determined at 208G to map signatures and/or attributes to data ingestion. For example, a hash table may be maintained in memory where the hash table maps a plurality of table signatures to one or more flush statistics and one or more ingestion statistics. These one or more ingestion statistics in the corresponding signature hash table may be incremented via compare-and-swap when one or more rows for an object are inserted into the IGA. Similarly, these one or more ingestion statistics in the corresponding signature hash table may be decremented via compare-and-swap when one or more rows for an object are flushed from the IGA to a table or a persistent storage device therefor. Some examples of ingestion statistics may include, without limitation, the total amount of insert data for a signature of or pertaining to a particular snapshot (e.g., “total_potential_insert_data_for_signature_in_snapshot”), the total insert time for a signature of or pertaining to a snapshot (e.g., “total_insert_time_for_signature_in_snapshot”), the total insert time waited for a signature of or pertaining to a snapshot (e.g., “total_insert_time_waited_for_signature_in_snapshot”).

With the table determined at 208G, a signature or an attribute may be identified at 209G. As described above, a signature for a table or schema may be defined by or comprise a pattern of bits that indicates presence or absence of one or more attributes of or pertaining to a table or a schema. Some examples of such attributes are described above with reference to 204G. For this signature identified at 209G, a snapshot may be identified at 210G. As described above, when compared to the embodiments illustrated in FIG. 2D, these embodiments illustrated in FIG. 2G maintain an array of averages for each table signature for a given snapshot of the multiple snapshots identified at 202G.

For the snapshot identified at 210G, an ingest rate (e.g., a potential ingest rate) may be determined at 212G. The process may return to 210G to identify a separate snapshot of the multiple snapshots that are identified at 202G and determine the ingest for the separate snapshot for the signature or attribute at 210G until all the snapshots of interest are similarly processed. A statistical ingest rate may be determined at 214G for the snapshots at least by performing a statistical operation on respective ingest rates for the multiple snapshots for the signature or attribute identified at 209G. The ingest rate and the statistical ingest rate may be respectively determined by using techniques described herein with reference to, for example, FIG. 2A, 2B, or 2D described above. The process may then return to identify a separate signature or attribute and repeat 209G through 214G to iterate through the signatures or attributes at 216G.

As described herein, determining a potential ingest rate and a statistical ingest rate based on the potential ingest rate may employ different techniques. For example, the process illustrated in FIG. 2A includes a set of static rules which, when triggered, invoke corresponding memory management tasks that grown or shrink an IGA by a fixed ratio, percentage, or size. The embodiments illustrated in FIG. 2B determine two statistical rates (ingest rate and flush rate averaged over each snapshot of a temporal duration) for each snapshot of a plurality of snapshots. In contrast, the embodiments illustrated in FIG. 2G provide a finer-grained control over a plurality of signatures of a table or schema based on a plurality of attributes of the table or schema in that these embodiments illustrated in FIG. 2G provide an array of statistical estimates (e.g., weighted averages) for each table signature (which is represented by a pattern of bits respectively indicating the presence or absence of a plurality of attributes of the table or schema) for a given snapshot of the multiple snapshots.

FIG. 2H shows more details about a portion of the block diagram illustrated in FIG. 2B in some embodiments. More specifically, FIG. 2H illustrates more details about determining a statistical flush rate at 210B of FIG. 2B. These embodiments compare and contrast with those described above with reference to FIG. 2E in that these embodiments estimate IGA activities (e.g., ingestion and flush) while being made aware of the schema and/or table(s). In these embodiments illustrated in FIG. 2H, multiple snapshots may be identified at 202H. For example, a snapshot may be captured for a 10-minute temporal duration within a two-hour moving temporal window. In some embodiments, a respective weight or multiplier may be optionally identified at 202H for each snapshot. These weights or multipliers may be the targets of training of a predictive model as the model parameters by using a training dataset with machine learning techniques described herein.

Multiple attributes of or pertaining to one or more tables and/or one or more schemas may be identified at 204H. A signature of a table (e.g., a database table) or a schema thereof may include a pattern of a plurality of bits each of which indicates the presence or absence of a corresponding attribute. Unlike the embodiments illustrated in FIG. 2E and described above, these embodiments illustrated in FIG. 2H account for finer granularity of the table(s) and/or schema(s) pertaining to the database(s) for which various types of data are flushed from the IGA to a table or a persistent storage therefor.

These multiple attributes may include at least one of the row data size(s) such as narrower rows and wider rows (e.g., the row size greater than 8 KB, or the number of columns greater than 255, etc.), compression of a table or one or more segments thereof, whether a table is indexed, whether the index is compressed, whether the data and/or index of a table is encrypted, transparent data encryption, one or more constraints on a table, or types of data in a table, or any other suitable, desired, or required attributes of or pertaining to a table or schema of a database for which data from various sources (e.g., IoT sources) is ingested into the IGA and flushed to a table (e.g., a database table) or a persistent storage therefor. In some embodiments, an attribute may be expanded into multiple attributes to create at least one finer-grained table attribute. For example, an index attribute having a binary index value (e.g., Y or N) may be expanded into a set of histogram-like buckets for a number of regular indices between a first value (e.g., 1 or 10) and a second value (e.g., 10 or 20). More details about these multiple attributes are described above with reference to FIG. 2G.

In the embodiments illustrated in FIG. 2E, tracking one average rate of flush across a diverse set of table signatures may lose vital information and my likely yield sub-optimal predictions for IGA growth and/or shrink. The embodiments illustrated in FIG. 2H aim to categorize the flush rate for each key table signature as determined by the set of attributes described above and use it to predict the flush rate more accurately. In some embodiments illustrated FIG. 2H, the aforementioned list of attributes is illustrative but not exhaustive, and a plethora of other schema or table attributes that may also influence performance.

A table signature may be determined at 206G by examining one or more catalog tables for an object of a plurality of objects having data in the IGA in some embodiments. In some of these embodiments, the plurality of objects is distinct from one another so that each object constitutes a distinct object. In some embodiments, a catalog table comprises a table that returns information about another table, or data source. In these embodiments where a computing system has one or more clusters, and a database server may be a cluster of the one or more clusters. A cluster may thus include one or more catalogs where a catalog may include one or more databases.

In some embodiments, a catalog (e.g., a database) may have one or schemas where a schema comprises the namespace of tables, and even the security boundary in some of these embodiments. These embodiments thus track the distinct objects or the total number thereof for which a table signature is generated or determined at 206H. Compared to the embodiments illustrated in FIG. 2E, these embodiments illustrated in FIG. 2H maintain an array of averages for each table signature for a given snapshot of the multiple snapshots identified at 202H.

A table (e.g., a has table) may be identified or determined at 208H to map signatures and/or attributes to data ingestion. For example, a hash table may be maintained in memory where the hash table maps a plurality of table signatures to one or more flush statistics. In some embodiments, some example flush statistics may comprise, without limitation, the total flush data for a signature in a particular snapshot (e.g., “total_flush_data_for_signature_in_snapshot”), or the total flush time for a signature of or pertaining to a particular snapshot (e.g., “total_flush_time_for_signature_in_snapshot”), or any other suitable, desired, or required statistics.

With the table determined at 208H, a signature or an attribute may be identified at 209H. As described above, a signature for a table or schema may be defined by or comprise a pattern of bits that indicates presence or absence of one or more attributes of or pertaining to a table or a schema. Some examples of such attributes are described above with reference to 204H. For this signature identified at 209H, a snapshot may be identified at 210H. As described above, when compared to the embodiments illustrated in FIG. 2E, these embodiments illustrated in FIG. 2H maintain an array of averages for each table signature for a given snapshot of the multiple snapshots identified at 202H.

For the snapshot identified at 210H, a flush rate (e.g., a potential flush rate) may be determined at 212H. The process may return to 210H to identify a separate snapshot of the multiple snapshots that are identified at 202H and determine the flush for the separate snapshot for the signature or attribute at 210H until all the snapshots of interest are similarly processed. A statistical flush rate may be determined at 214H for the snapshots at least by performing a statistical operation on respective ingest rates for the multiple snapshots for the signature or attribute identified at 209H. The flush rate (e.g., the potential flush rate) and the statistical flush rate may be respectively determined by using techniques described herein with reference to, for example, FIG. 2A, 2B, or 2E described above. The process may then return to identify a separate signature or attribute and repeat 209H through 214H to iterate through the signatures or attributes at 216H.

As described herein, determining a potential ingest rate and a statistical ingest rate based on the potential ingest rate may employ different techniques. For example, the process illustrated in FIG. 2A includes a set of static rules which, when triggered, invoke corresponding memory management tasks that grown or shrink an IGA by a fixed ratio, percentage, or size. The embodiments illustrated in FIG. 2B determine two statistical rates (ingest rate and flush rate averaged over each snapshot of a temporal duration) for each snapshot of a plurality of snapshots. In contrast, the embodiments illustrated in FIG. 2H provide a finer-grained control over a plurality of signatures of a table or schema based at least in part on a plurality of attributes of the table or schema in that these embodiments illustrated in FIG. 2H provide an array of statistical estimates (e.g., weighted averages) for each table signature (which is represented by a pattern of bits respectively indicating the presence or absence of a plurality of attributes of the table or schema) for a given snapshot of the multiple snapshots.

FIG. 2I shows more details about a portion of the block diagram illustrated in FIG. 2B in some embodiments. More specifically, FIG. 2I illustrates more details about determining a statistical ingest rate at 204B or determining a statistical flush rate at 206B of FIG. 2B. In these embodiments illustrated in FIG. 2I, multiple snapshots pertaining to IGA ingestion and/or flush may be identified at 202I for a temporal duration within a temporal window. For example, a snapshot may be captured for a 20-minute temporal duration within a four-hour moving temporal window. In some embodiments, a respective weight or multiplier may be optionally identified at 202I for each of the multiple snapshots. In some embodiments, these weights or multipliers may be normalized. For example, these weights or multipliers may be normalized in such a way that the summation of these weights or multipliers equals to one (“1”). These weights or multipliers may be the targets of training of a predictive model as the model parameters by using a training dataset with machine learning techniques described herein.

A signature may be generated at 204I for each object of multiple objects that have data in the IGA, at least by examining one or more catalog tables. A table (e.g., a hash table) may be maintained at 206I where the table maps each signature to one or more ingestion statistics and/or one or more flush statistics. Some examples of ingestion statistics may include, without limitation, the total amount of insert data for a signature of or pertaining to a particular snapshot (e.g., “total_potential_insert_data_for_signature_in_snapshot”), the total insert time for a signature of or pertaining to a snapshot (e.g., “total_insert_time_for_signature_in_snapshot”), the total insert time waited for a signature of or pertaining to a snapshot (e.g., “total_insert_time_waited_for_signature_in_snapshot”). In some embodiments, some example flush statistics may comprise, without limitation, the total flush data for a signature in a particular snapshot (e.g., “total_flush_data_for_signature_in_snapshot”), or the total flush time for a signature of or pertaining to a particular snapshot (e.g., “total_flush_time_for_signature_in_snapshot”), or any other suitable, desired, or required statistics.

Th one or more ingest statistics and/or the one or more flush statistics may be optionally updated at 208I using, for example, compare-and-swap (CAS) instruction, without using any locking mechanisms. Compare-and-swap is an atomic instruction that compares the contents of a memory location with a given value and, only if they are the same, modifies the contents of that memory location to a new given value. Compare-and-swap is done as a single atomic operation where the atomicity guarantees that the new value is calculated based on up-to-date information.

For each signature of the multiple signatures, the number of objects corresponding to the signature may be tracked at 210I because some objects may pertain to a particular attribute that is present in certain signatures but absent from the other signatures. For example, a segment or partition of a table may be encrypted or compressed, the data of objects ingested into the IGA and eventually flushed to the segment or partition of the table or the persistent storage therefor will be associated with the signatures have the appropriate bit(s) indicating the presence of such compression or encryption while other objects not eventually flushed to the segment or partition of the table or the persistent storage therefor may be associated with different signatures having the same bit(s) indicating the absence of such compression or encryption.

For each snapshot of the multiple snapshots identified at 202I, a plurality or array of statistical rates may be determined for the snapshot at 212I. In some embodiments, an array of statistical ingest rates may be determined for each snapshot of the multiple snapshots to respectively correspond to a plurality of signatures. That is, when compared with the embodiments illustrated in FIGS. 2D-2E (FIG. 2D for ingestion and FIG. 2E for flush) that provide two statistical rates (e.g., a statistical ingest rate and a statistical flush rate), the embodiments illustrated in FIG. 2I provide an array of statistical rates for each snapshot of the multiple snapshots and thus provide a finer-grained control over the estimate of IGA activities (e.g., ingestion activities and flush activities).

A determination may be made by, for example, the memory management coordinator process or service at 214I to determine how many tables are enabled for ingestion and flush with techniques described herein based at least in part upon information of one or more catalog tables that respective comprise a table that returns information about another table or one or more data sources.

A statistical ingest rate and a statistical flush rate may be determined at 216I. In some embodiments, determining a statistical ingest rate and a statistical flush rate may comprise examining one or more attributes that are present (e.g., having bit values of one (“1”) at the one or more corresponding bit locations in these signatures). Moreover, a count of objects may be generated per distinct signature (e.g., a distinct pattern of bits that respectively correspond to the one or more attributes that are present). A potential ingest rate may be determined for each distinct signature where the potential ingest rate may comprise a normalized potential ingest rate that is determined based at least in part upon an average number of objects per signature across the multiple snapshots as well as the current number of objects per signature.

In some embodiments, the statistical ingest rate may be determined based at least in part upon a weighted average over the multiple snapshots. For example, the process illustrated in FIG. 2D may be employed to determine the aforementioned weighted average over the multiple snapshots for the statistical ingest rate. Similarly, the statistical flush rate may be determined based at least in part upon a weighted average over the multiple snapshots. For example, the process illustrated in FIG. 2E may be employed to determine the aforementioned weighted average over the multiple snapshots for the statistical flush rate. The statistical ingest rate may be optionally scaled up or down based at least in part upon a historical average of existing objects for a distinct signature and a total of objects currently present in some embodiments.

A statistical ingest rate may be optionally determined at 2181 for each signature of the multiple signatures based at least in part upon a statistical count of objects for the signature across the multiple snapshots identified at 202I as well as the current count of objects for the same signature. A statistical flush rate may be similarly determined at 2201 for each signature of the multiple signatures based at least in part upon the statistical count of object for the signature across the multiple snapshots as well as the current count of objects for the same signature in some embodiments. In some embodiments, the statistical ingest rate and/or the statistical flush rate may be normalized. The statistical ingest rate and/or the statistical flush rate may be optionally scaled at 2221 based at least in part upon a past or historical average of existing objects for each signature as well as the total count of objects then present for the same signature.

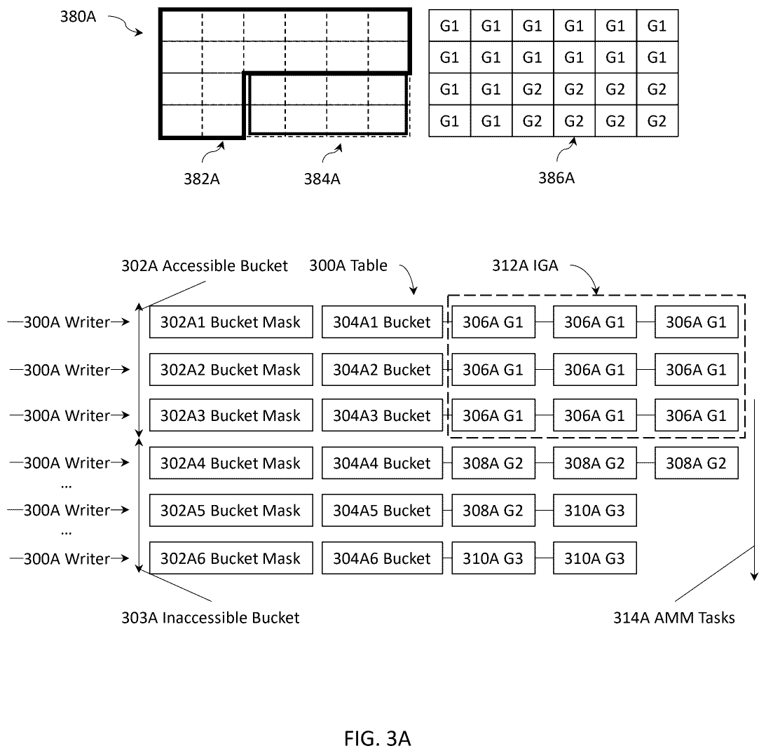

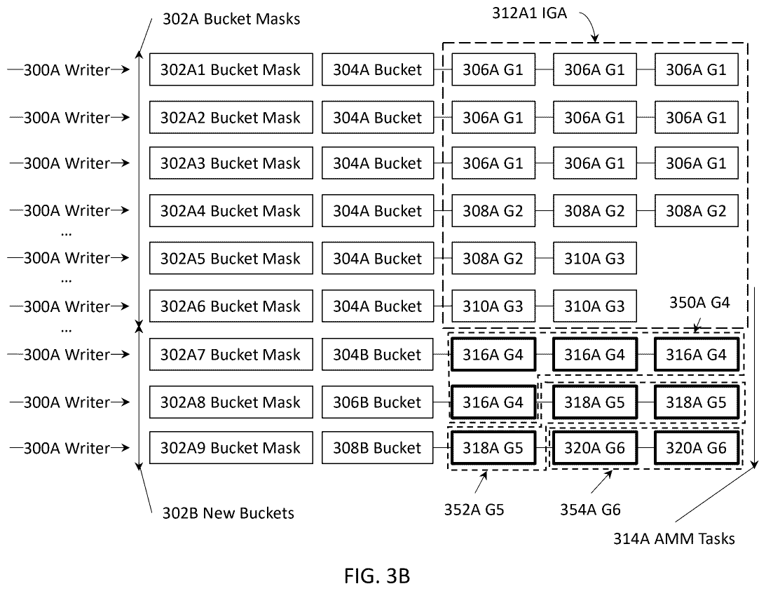

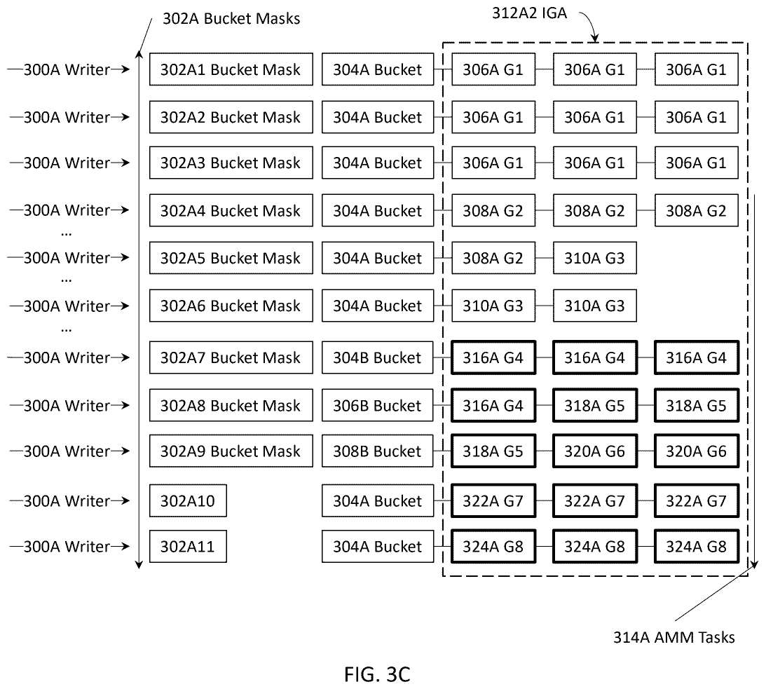

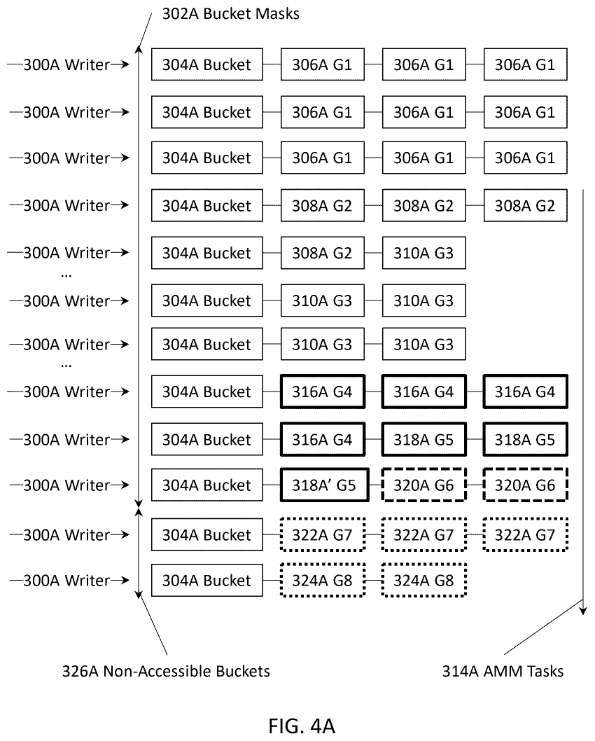

FIGS. 3A-3C illustrate some simplified examples for adaptive memory management for data ingestion and flush according to some embodiments. In these embodiments, 380A represents a memory region such as a memory region in a large pool (e.g., 139A in FIG. 1A) allocated to the Ingest Global Area (IGA). In these embodiments, a size of memory in SGA to grow the IGA may be dynamically (e.g., on the fly, in real-time, or in nearly real-time due to latency caused by signal transmissions) determined. In some embodiments, a size to grow the IGA may be determined by min((_iga_adaptive_max_size−current-iga-size), (_iga_adaptive_growth_percent*current-iga-size)) or other methods described above with reference to FIG. 2A, 2B, 2D, or 2G. The bucket mask may be updated to reflect an active range of buckets in the IGA after growing the IGA by the size. One or more granules in memory may be allocated based at least in part upon the size of memory in the SGA to be allocated (e.g., 2 granules for a total of 2 GB memory to be allocated). One or more additional hash table buckets each having one or more buffers may then be created, and the bucket mask may be modified to avail the size of the memory to writers. In some embodiments, the buckets may be created before the bucket mask is modified to prevent foreground and/or background processes to obtain the buffers in the one or more newly allocated granules.

For example, one or more granules in the large pool may be allocated based at least in part upon the size of the memory region 380A. In the example illustrated in FIG. 3A, three granules 382A (G1), 384A (G2), and G3 (not shown in 380A) in the large pool or the System Global Area (SGA) are allocated for the IGA which may include zero or more additional granules which are not shown in FIG. 3A for the ease of illustration and description. A table 300A (e.g., a hash table) having a plurality of buckets (or slots) may be created for the IGA where each bucket corresponds to one or more buffers in the IGA. In the example illustrated in FIG. 3A, the hash table corresponds to the current state of the IGA 312A. The current state of the IGA 312A corresponds to three buckets 304A1, 304A2, and 304A3.

The table 300A corresponds to or comprises the bucket mask 302A. A bucket mask comprises a counter that indicates an active range of buckets in the IGA and is used for concurrency control between writers 300A and memory management growth and shrink tasks 314A. Writers 300A may only write data into this active range as indicated by the bucket mask 302A. When a memory management task grows the IGA after memory allocation, the bucket mask 302A may be increased to cover the additional memory allocation to the IGA. On the other hand, when the IGA 312A is shrunk, the bucket mask 302A may be first reduced (which then gates off new writers), and then the buffers corresponding to the corresponding bucket(s) are deallocated.

In the example illustrated in FIG. 3A, the current state of the IGA is represented as 312A, and the bucket mask 302A1, 302A2, and 302A3 of 302A thus indicate the active range of buckets that encompasses buckets 304A1, 304A2, and 304A3 each of which comprises one or more respective buffers 306A. Before the IGA 312A is grown to include the additionally allocated memory (e.g., from granule G2 384A), the bucket mask 302A indicates that the newly allocated buckets 302A4, 302A5, and 302A6 are inaccessible as reflected by 303A. That is, the bucket mask 302A is not yet expanded to encompass these inaccessible buckets 304A4, 304A5, and 304A6 respectively having the buckets 308A in granule G2 and the buckets 310A in granule G3 schematically shown by 303A. In some embodiments, the bucket mask has a sequence of bits to indicate whether a bucket is accessible or inaccessible. Once the IGA is grown to include the newly added buckets (308A in granule 1 and 310A in granule 2), the bucket mask 302A may be expanded to indicate that the buckets 306A in granule 1, 308A in granule 2, and 310A in granule 3 are active, available.

A bucket mask such as 302A is distinct from a bucket latch (not shown) in some embodiments where a bucket latch is used to control bucket-level actions such as a writer grabbing a buffer, a memory management coordinator process or service deallocating a buffer, or a flusher background process marking a buffer free after flushing the content of the buffer to a table or a persistent storage device therefor, etc. A bucket latch comprises a per-bucket latch that controls bucket-level actions such as a writer grabbing a buffer, AMM coordinator de-allocating a buffer or a flusher marking the buffer free after flushing its contents to disk, etc.

In some embodiments, a bucket latch serializes access to a buffer. In some of these embodiments, a writer process may obtain a buffer by imposing a bucket latch on the bucket level. If the writer process subsequently goes to sleep, the bucket latch may also prevent the lathed writer process from going back to the same buffer if the content of the buffer has changed (e.g., when the buffer has been flushed because of a periodic flush even though the buffer is not necessarily full). Bucket latches and enqueues are two types of locks. Bucket latches are lightweight serialization devices that serialize access to in-memory data structures (e.g., SGA or IGA data structures). When a process tries to obtain a bucket latch, the process may spin for a while and try again until the process obtains the bucket latch. While the current implementation uses a latch, a compare-and-swap-based (CAS-based) design is possible to make the algorithms completely “lockless”.

For example, when a writer process requests a buffer, the writer process first checks the status of the bucket in a lockless fashion. If the bucket is available, then the writer process grabs the bucket latch, performs the check again, and grabs a free buffer in some embodiments. The bucket lock is needed to ensure that two writer processes do not race for the same buffer. In these embodiments, a writer process determines whether a bucket includes a free buffer by determining whether the bucket is available. That is, a process may land on a bucket without knowing whether the bucket includes any free, available buffers in some embodiments.

In these embodiments, the writer process is made aware that there is a free buffer in the IGA but does not necessarily know which bucket includes the free buffer. In these embodiments, the writer process first performs a quick, lockless check against the metadata to determine whether a bucket is available. If the writer process determines that a specific bucket includes a free buffer, the writer process obtains a bucket latch that locks the bucket comprising a free buffer to prevent other writer processes from competing for the same buffer.

A check may be performed again on the bucket mask again to ensure that the buffer or the bucket is available to prevent multiple writer processes from racing for the same buffer. If the check result is affirmative (buffer or bucket is available), the writer process obtains the buffer at least by caching the address of the buffer corresponding to the bucket in the memory region allocated for the writer process. In some other embodiments, rather than using a bucket latch (which may be deemed as a form of a lock), the aforementioned operations may be made completely lockless by using compare-and-swap (CAS) to stamp the session identifier (identifying a unique writer) on the buffer. In these latter embodiments, operations performed using a bucket latch may be replaced with full, equal effects with compare-and-swap.

FIG. 3B illustrates an example of growing the IGA 312A1 to further include additional memory allocation of memory including 316A in granule 4 (350A), 318A in granule 5 (352A), and 320A in granule 6 (354A). Before the IGA 312A1 is grown to include the newly allocated buckets 304B, 306B, and 308B, the bucket mask 302A indicates that buckets 302A1, 302A2, 302A3, 302A4, 302A5, and 302A6 are available.

In some embodiments, the bucket mask 302B (which may be different fields in the same bucket mask as 302A) indicates that buckets 302A7, 302A8, and 302A9 are inaccessible, unavailable until the IGA 312A1 is grown to include the buffers in the additional memory allocation of memory including 316A in granule 4 (350A), 318A in granule 5 (352A), and 320A in granule 6 (354A). Once the IGA 312A1 is grown via a memory management task 314A to include such additional allocation, the bucket mask 302A may be expanded to indicate that the accessible, available bucket range now includes the buckets 304A, 304B, 306B, and 308B.

FIG. 3C illustrates another example of first growing the IGA 312A1 into the grown IGA by allocating granule 4 (including the buffers 316A in buckets 304B and 306B), granule 5 (including the buffers 318A in buckets 302A8 and 302A9), and granule 6 (including buffers 320A in bucket 302A9) as shown in FIG. 3B and described above. FIG. 3C further illustrates growing the IGA into IGA 312A2 by further allocating granule 7 (including the buffers 322A in bucket 302A10) and granule 8 (including the buffers 324A in bucket 302A11).

Once the IGA is grown to include the newly allocated buffers, the bucket mask 302A is increased or expanded to indicate that the available, accessible buckets now encompass buckets 302A1 through 302A11 as shown in FIG. 3C. The IGA 312A2 now includes eight granules (306A G1, 308A G2, 310A G3, 316A G4, 318A G5, 320A G6, 322A G7, and 324A G8) that each respectively comprise two or three buckets. In some embodiments, each bucket includes the same number of buffers that are connected for the bucket through a singly linked list. In some other embodiments, one or more buckets may include a different number of buffers than the remaining buckets. In these latter embodiments, the total numbers of buffers of the buckets are nevertheless maintained in such a way so that the spread of these total numbers of buffers is less than a threshold number (e.g., one, two, etc.) For example, most of the buckets in FIG. 3C have three equally-sized buffers while two buckets have two buffers so that the spread of the total numbers of buffers is one (“1”). This threshold number may be imposed to avoid preferential or biased selection of buckets by writer processes in some embodiments.

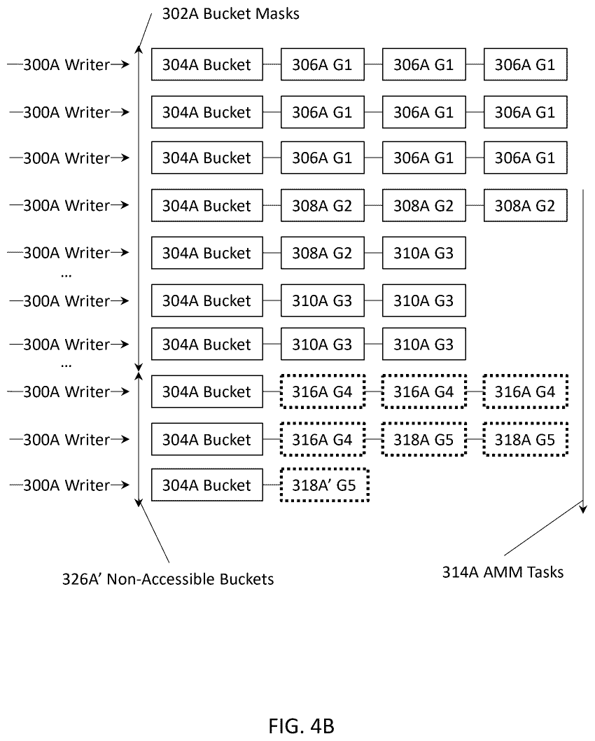

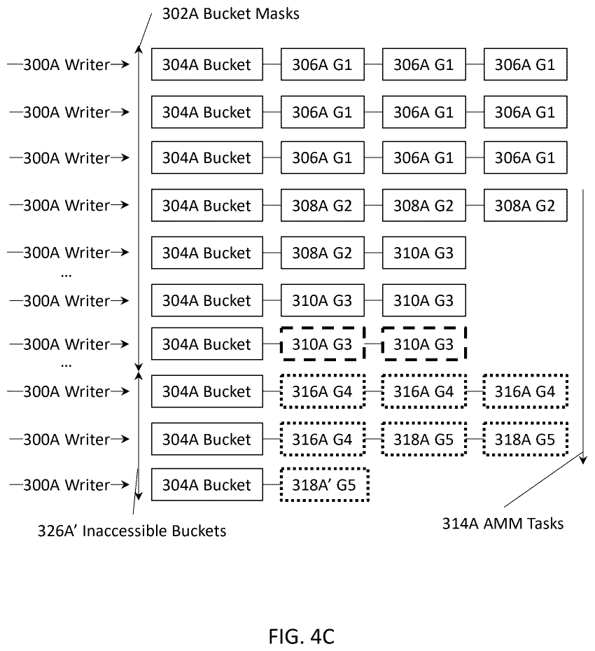

FIGS. 4A-4C illustrate some simplified examples for adaptive memory management for data ingestion and flush according to some embodiments. More specifically, FIGS. 4A-4C illustrate some simplified examples for adaptive memory management tasks of shrinking the IGA. In the example illustrated in FIG. 4A, the IG is to undergo a shrink operation that reduces the allocation of memory for the IGA. The IGA currently comprises eight granules (306A G1, 308A G2, 310A G3, 316A G4, 318A G5, 318A′ G5 in a different bucket, 320A G6, 322A G7, and 324A G8). A memory management task is determined to shrink the current state of the IGA by a certain percentage, ratio, or amount.

Moreover, the memory management task is to execute an IGA shrink operation on the IGA by first masking off one or more buckets to be deallocated or shrunken so that writer processes do not obtain buffers from these one or more buckets. In comparison, a bucket latch (which is also a bucket-level lock or latch) may be used to prevent writer processes from competing for the same buffer although these writer processes may still land on the same bucket yet for different buffers because a bucket latch serializes access to the buffers in a bucket and is thus associated with the bucket so that multiple writer processes may still obtain different buffers in the same bucket. It shall be noted that the use of bucket latch may be replaced with compare-and-swap (CAS) operations to accomplish the same purpose.

In this example illustrated in FIG. 4A, the buckets in granules G1 (306A) through G3 (310A) represent the then-current memory allocation for the IGA. Granule G4 (316A) through granule G8 (324A) represent increased memory allocation for the then-current memory allocation where the buffers in granule G5 (318A) and granule G6 (320A) denote granule-dependent buffers. These examples in FIGS. 4A-4C illustrate an IGA shrink operation that deallocate, for example, the buffers in granule G7 (322A) and granule G8 (324A).

In some embodiments, the process (e.g., by the memory management coordinator process or service) dynamically determines a size of memory in the IGA to shrink. For example, the size to shrink the current IGA by may be determined by using min((current-iga-size−_iga_adaptive_min_size), (iga adaptive shrink percent*current-iga-size)) or other suitable algorithm described herein or any other suitable algorithms (e.g., algorithms based on the workload, the system hardware configuration, seasonal variations, usage patterns, etc.)

One or more hash table buckets whose buffers are to be deallocated as a part of a shrink process may be identified. In some embodiments, this process may include identifying the one or more hash table buckets based at least in part on a respective number of free buffers for each of the one or more hash table buckets. In some embodiments, the one or more hash table buckets have a consistent number of buffers to avoid contention on hash buckets with fewer buffers, and the consistent number may be constrained within a threshold number (e.g., one, two, etc.) as described herein. The bucket mask may be modified to reflect that a number of active buckets are made inaccessible to writer processes to prevent new writer processes from obtaining a buffer in the one or more hash table buckets.

Moreover, a special check may be performed via compare-and-swap (CAS) to ensure that the shrink process is safe in the presence of concurrent writer processes and flusher processes. One or more granules corresponding to the one or more buckets are then deallocated to shrink the IGA, and the IGA metadata (e.g., total number of buckets, the current size of IGA, or the number of granules in the IGA, or any other suitable metadata) may be updated accordingly.

In the examples illustrated in FIGS. 4A-4C, the bucket mask is first updated in response to a memory management task 314A to shrink the IGA by indicating that the buffers (318A′ through 324A) in the corresponding buckets are inaccessible as shown by 326A′ to prevent writer processes from obtaining buffers in these buckets while the buffers (304A through 318A) in the remaining buckets remain accessible as indicated in the bucket mask 302A.

FIG. 4B illustrates a shrunk IGA after the memory management task 314A that has deallocated the buffers (318A′ through 324A in FIG. 4A) in the corresponding buckets. Moreover, FIG. 4B further illustrates a separate memory management task 314A is to further deallocate the buffers 316A through 320A in the last three buckets. As described above, the bucket mask may be first updated to indicate that these buffers 316A through 320A are inaccessible as shown by 326A′ to prevent writer processes from obtaining any of these buffers to be deallocated for data ingestion while the buffers 306A through 310A (respectively corresponding to granules G1 through G3) remain available as indicated in the bucket mask 302A.

FIG. 4C illustrates more details about IGA shrink operations. More particularly, suppose another IGA shrink operation is to deallocate granules G4 and G5 (including buffers 316A and 318A). Granules G5 and G4 may be deallocated together, but granule G4 by itself may not because granule G4 is shared between two buckets. In some embodiments, the process (e.g., the memory management coordinator process or service) may examine the most recently allocated granules and/or buckets to determine whether a granule or a bucket may be deallocated. In this example illustrated in FIG. 4C, if the process has determined to deallocate the last bucket including one buffer 316A in granule G4 and two buffers 318A in granule G5, the process may examine the next most recently allocated bucket or the granules to be deallocated.

For example, the process may examine whether the second bucket from the bottom including one buffer 316A in granule G4 and two buffers 318A in granule G5 and determine that granule G5, if not shared by multiple buckets, may be deallocated. Nonetheless, granule G4 is shared by the two more recently allocated buckets. The process may further examine whether the second bucket from the bottom may be deallocated. If the determination is affirmative (e.g., such deallocation conforms to the size for deallocation, the granules to be deallocated are not shared by multiple buckets, etc.), the process may then add the second bucket from the bottom to the list of buckets or granules for deallocation.

The process may further examine the next most recently allocated bucket (the third bucket from the bottom) which includes two buffers in granule G3. The process may then determine that the third bucket from the bottom may not be deallocated because these two buffers are in granule G3 that is shared by multiple buckets, and further because deallocating more buckets (e.g., the fourth bucket adjacent to the third bucket from the bottom) does not comply with the determination of deallocation (e.g., size shrinkage exceeds the determined size for shrinking or exceeds the determined size by a threshold amount or percentage). In this scenario, the process (e.g., the memory management coordinator process or service) may then determine to deallocate only the last two adjacent granules G4 and G5, without deallocating the third bucket from the bottom although this third bucket includes buffers that are immediately adjacent to the buffers to be deallocated.

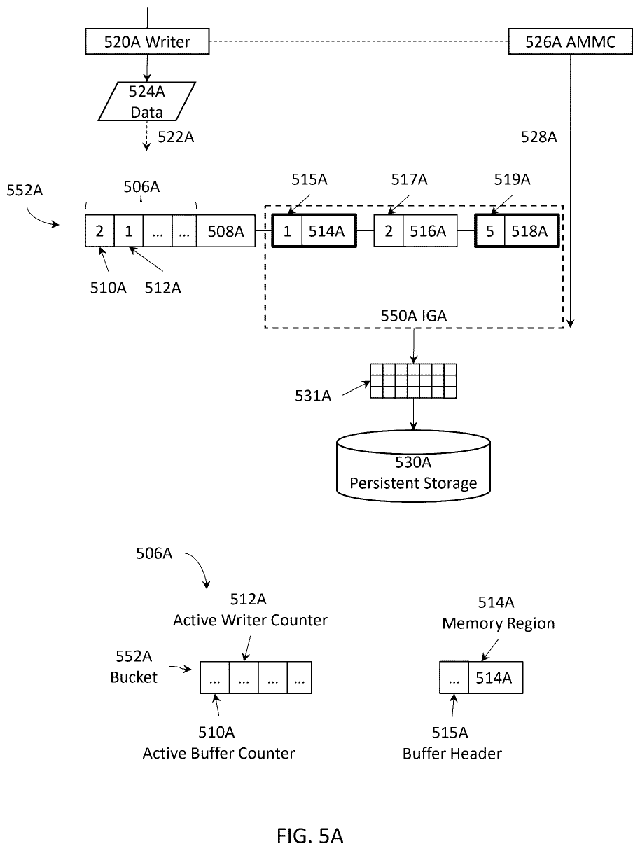

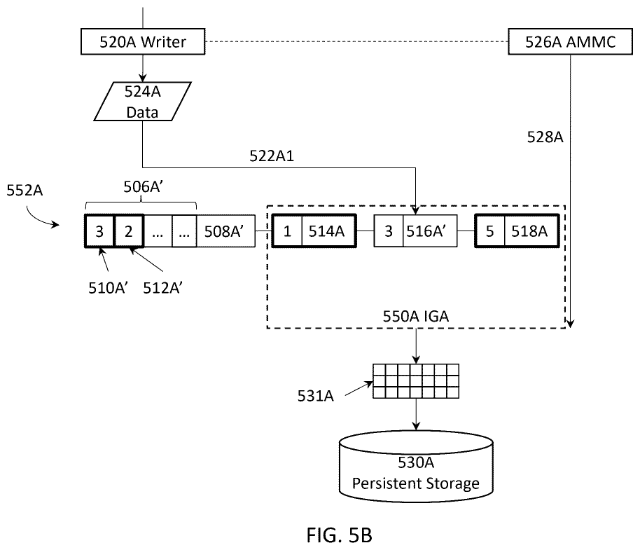

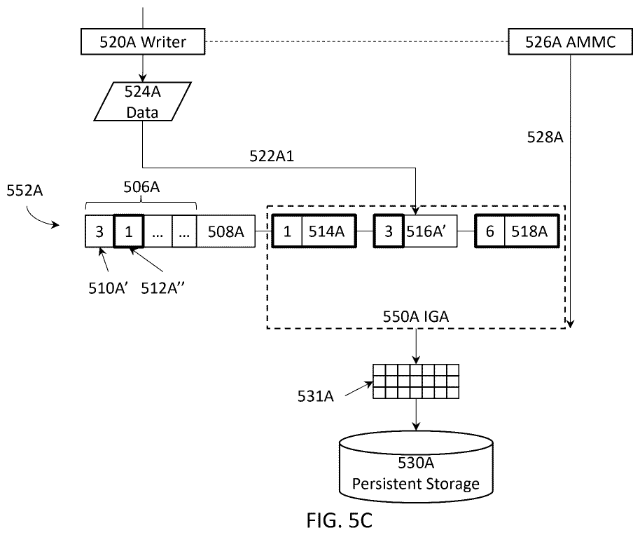

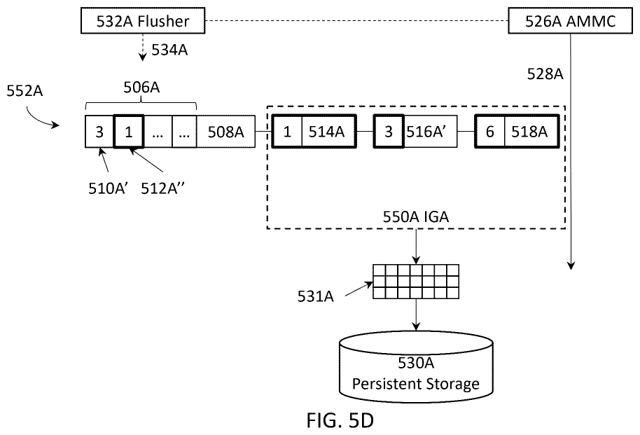

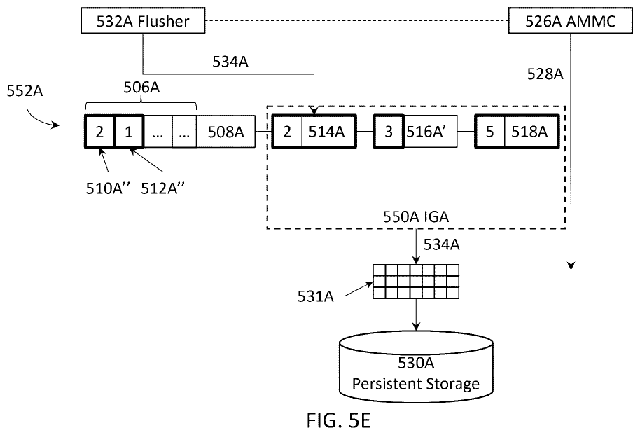

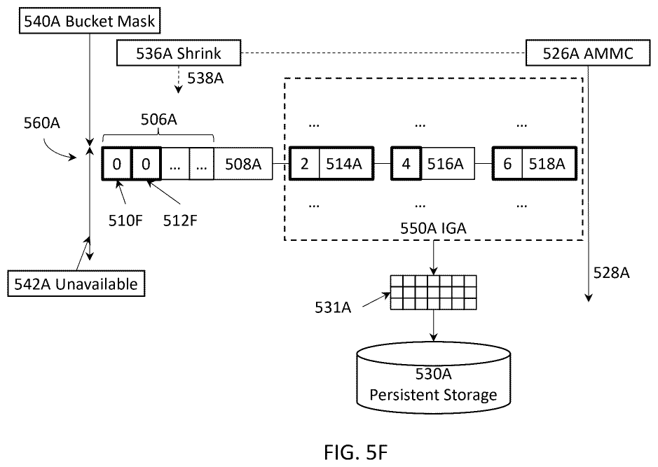

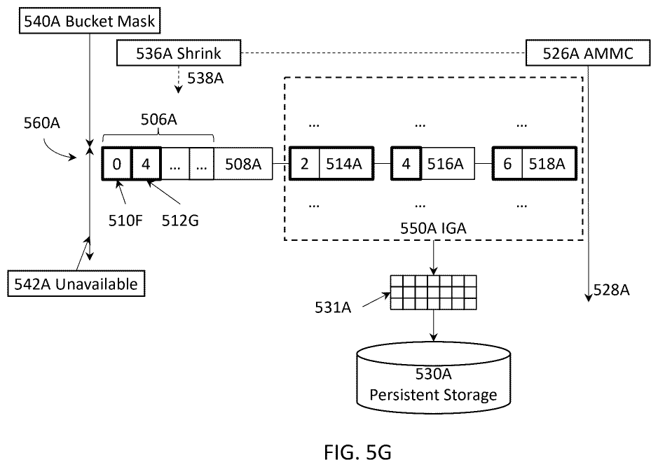

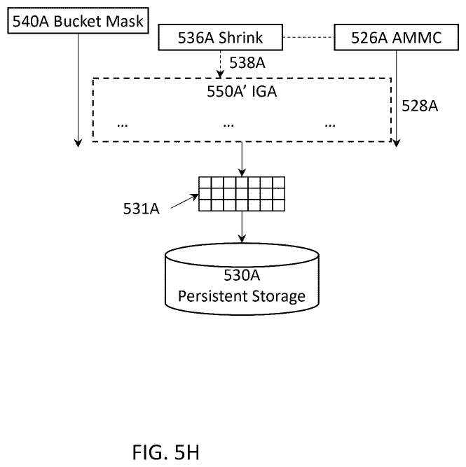

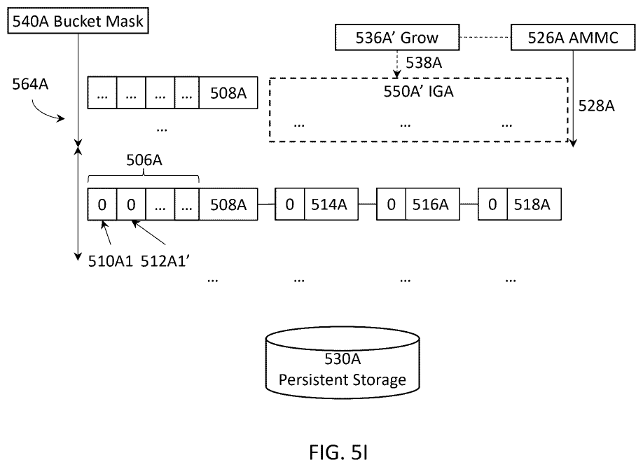

FIGS. 5A-5H illustrate some simplified examples for adaptive memory management for data ingestion and flush according to some embodiments. More specifically, FIGS. 5A-5H illustrate more details about various processes such as the foreground writer process, the background flush process, etc. as well as the corresponding operations arising out of such processes described herein. FIG. 5A illustrates a foreground writer process 520A attempts to obtain one or more buffers in the IGA and write data 524A to an IGA by coordinating with the automatic memory management coordinator 526A that executes or invokes the execution of one or more memory management tasks 528A on the IGA 550A.

The IGA 550A is shown with only one bucket corresponding or having a bucket mask 552A that corresponds to three buffers 514A, 516A, and 518A. Each of these three buffers has a buffer header (e.g., header 515A for buffer 514A, header 517A for buffer 516A, and header 519A for buffer 518A). A buffer header may store therein one or more pieces of information or data such as a version counter described herein. In these simplified examples illustrated in FIGS. 5A-51, a binary-value version counter is illustrated for the ease of illustration and description although other types of version counter may also be used. Further, only one bucket having three buffers is illustrated in FIG. 5A also for the ease of illustration and description although an IGA may correspond to a plurality of buckets each having the same or different number of buffers.

In these embodiments, a version counter having an even value indicates that the buffer is free, accessible, and available while a version counter having an odd value indicates that the buffer is inaccessible and unavailable for writer processes. For example, the buffer 514A has a version counter value of one (“1”), and the buffer 518A has a version counter value of five (“5”). These two odd values indicate that both buffers 514A and 518A are “locked” (inaccessible and unavailable) to prevent other writer processes from obtaining these two buffers. On the other hand, the buffer 516A has a version counter value of two (“2”). This even value indicates that the buffer 516A is not “locked” (accessible and available) so other writer processes may obtain this buffer by imposing a bucket latch to claim exclusive access to this buffer 516A.

The bucket 552A corresponds to or comprises a bucket mask 508A that is a bucket-level counter that serializes access to the buffers in the bucket 552A. The bucket 552A further corresponds to or comprises one or more data structures or fields 506A that respectively store one or more corresponding values or one or more pieces of information. For example, the one or more data structures or fields 506A may include a first field 510A for the active buffer counter. An active buffer counter includes a bucket-level counter which indicates the total number of buffers that have pending writes to be flushed in some embodiments. An active buffer counter may be used for concurrency control between writer processes, the memory management coordinator, and flusher processes. In some of these embodiments, when a writer process uses a buffer in a bucket, this active buffer counter value is atomically increased by 1 (or any other suitable value). On the other hand, when a buffer's contents are flushed to a table (e.g., a database table) or a persistent storage therefor, the active buffer counter value may be atomically decreased by 1 or any other suitable value. In this example illustrated in FIG. 5A, the active buffer counter has a value of two (“2”) that indicates that the bucket includes two buffers (out of the total three buffers) that have pending writes to be flushed.

The one or more data structures or fields 506A may further include a field 512A for storing the active writer counter. As described herein, an active writer counter is a bucket-level counter and is used for concurrency control between writer processors who may have cached buffer addresses and the memory management coordinator. In some embodiments, writer processes cache respective buffer addresses for performance reasons—caching buffer address(es) ensures that every writer need not go through the relatively more expensive process of obtaining a buffer for every write operation.

Rather, for the duration of a writer process session, a writer process may request a free buffer once, cache the address of the buffer, and keep using the same buffer for subsequent writes until the buffer memory region (e.g., 1 MB contiguous memory space) is full. In this example in FIG. 5A, the active writer counter has a value of one (“1”) that indicates that there is one active writer process that obtains a buffer (e.g., 516A whose buffer head includes an even number version number of “2”) in the bucket and writes to the buffer in the bucket 552A. The one or more data structures or fields 506A may include one or more additional fields or data structures for storing one or more other values, etc. FIG. 5A further illustrates one or more background processes (e.g., flusher processes or services) in the memory management tasks 528A that flush data in the IGA to a table 531A (e.g., a database table) and/or to persistent storage 530A.

FIG. 5B illustrates that the writer process 520A obtains a buffer 516A′ from the bucket 552A and writes data 524A to the buffer 516A′. The writer process 520A first checks the status of the bucket 552A in a lockless fashion (e.g., by checking the metadata associated with the bucket where the metadata may be updated when a buffer in a bucket becomes available or unavailable) to determine whether the bucket 552A includes a buffer that is available. The writer process 520A then determines that the bucket 552A does include an available buffer with this lockless check. The writer process 520A then checks the active writer counter 512A to see if the active writer counter value 512A (having a value of one “1” before the writer process obtains a buffer from the bucket 552A) is less than a threshold value.

For example, the writer process 520A may determine via compare-and-swap (CAS) whether the active writer counter value (currently at one or “1” as shown in 512A) is less than the total number of buffers (which is assumed to be three or “3” in this example) in the bucket 552A plus one (“1”) or four (“4”) in this example in some embodiments. In these embodiments, the total number of buffers (assumed to be three or “3” which happens to be the active buffer counter value in this example) in the bucket 552A plus one (“1”) or four (“4”) is used to indicate that the bucket 552A is locked for a shrink operation. On the other hand, if the active writer counter value 512A (currently at one or “1” as shown in 512A) is less than the total number of buffers (which is assumed to be three or “3”) in the bucket 552A plus one (“1”) or four (“4”), this indicates that this bucket 552A is not yet shrunk because the active buffer counter value is non-zero indicating there is buffer(s) with pending writes, and the writer may obtain a buffer (e.g., 516A′) from the bucket 552A by imposing a bucket latch and further by incrementing the active writer counter value of one (“1”) in 512A FIG. 5A by one (“1”) to the updated active writer counter value 512A′ of two (“2”) as shown in FIG. 5B.

The writer process 520A may further perform another check to determine which buffer is available in the bucket 552A. In this example, the writer process 520A may access the bucket mask that serializes access to the buffers in the bucket 552A and discovers that the version counter value of the buffer 516A is currently two “2” which indicates that the buffer is available (assuming an odd version counter value indicates that a buffer is accessible, available). The writer process 520A may than obtain the buffer 516A′ by updating its version counter value from two (“2”) to three (“3”) or another odd number to “lock” the buffer 516A′.

Once the writer process 520A “locks” the buffer 516A′ and writes data 524A to the buffer 516A′, the bucket 552A now includes three buffers that contain data to be flushed (either because buffers are full or because of a periodic flush despite the fact that a buffer may not necessarily be full). The active buffer counter 510A may then be updated from the then-current value of two (“2”) in FIG. 5A to the current value of three (“3”) as shown in 510A′ in FIG. 5B either before (but after the writer process 520A obtains the buffer 516A) or after the writer process 520A writes data to the buffer 516A′ so that the one or more data structures or fields 506A in FIG. 5A is now updated into 506A′ due to the updated value in the active buffer counter 510A′.

FIG. 5C illustrates an example where the writer process 520A begins and then finishes a write operation 522A1 to add data 524A to the memory region of the buffer 516A. Once the writer process 520A finishes the write operation 522A1 to the buffer 516A′, the writer process 520A decrements the active writer counter value of two (“2”) in FIG. 2B by one (“1”) so that the current active writer counter value is currently at one (“1”) as shown in 512A″.

The version counter value for the buffer 516A remains at three (“3”) to indicate that the buffer 516A together with the buffers 514A and 518A (hence a total of three buffers for the active buffer value 510A′) have pending data to be flushed to the table 531A and/or to the persistent storage 530A.

FIG. 5D illustrate an example where a background flusher process 532A attempts to flush some data in the IGA to the table 531A and/or the persistent storage 530A. In these embodiments, the flusher process 532A checks the active buffer counter 510A′ to determine that there are three buffers that have pending writes to be flushed. In some embodiments, the flusher process 532A learns that there is (are) pending write (writes) to be flushed because the active buffer counter 510A′ now has a non-zero value.

FIG. 5E illustrates an example in which the flusher process 532A attempts to flush data in the IGA to the table 531A and/or the persistent storage 530A. In these embodiments, the flusher process 532A determines that the bucket 552A has pending write(s) to be flushed because the active buffer counter 510A″ has a non-zero value as described with reference to FIG. 5D above. The flusher process 532A then identifies a buffer (e.g., 514A) in the bucket 552A and checks the version counter of this buffer to discover that this buffer 514A has an odd value three (“3”) and thus contains data to be flushed because this buffer 514A was locked by a writer process that wrote data to the buffer. The flusher process 532A then checks the active writer counter 512A″ to determine that no writer process is active writing data to this buffer 514A (assuming that the active writer counter value of one indicates that a writer process such as 520A is actively writing to buffer 516A as described above).

Once the flusher process 532A determines that no active writer process is writing data to the buffer 514A, the flusher process 532A performs a flush operation 534A that flushes the data in the buffer 514A to the table 531A and/or the persistent storage 530A. Once the flusher process 532A finishes flushing the data of the buffer 514A, the flusher process 532A updates the version counter value of the buffer 514A from the value of one (“1”) to two (“2” or a different even number) that indicates that this buffer 514A is again available for writer processes to write data to. The flusher process 532A may then update the active buffer counter 510A′ into 510A″ by decrementing the active buffer counter value 510A′ of three (“3”) by one (“1”) so that the active buffer counter 510A″ now has a value of two (“2”).

FIG. 5F illustrates an example of an IGA shrink operation 538A in some embodiments. More specifically, it may be determined (e.g., by the automatic memory management coordinator process or service 526A) that the memory allocation to the IGA may be reduced by an IGA shrink task 536A of the memory management task 528A. One or more buckets may be identified for the memory management task 528A based at least in part upon the respective numbers of free buffers for the one or more buckets. For example, the automatic memory management coordinator 526A may identify the bucket 560A for deallocation as a part of the IGA shrink task 536A. With the one or more buckets identified, the bucket mask 540A may be updated to mark the one or more identified buckets as unavailable as indicated by 542A and/or to remove the one or more buckets from the available buckets for the IGA 550A.

With the bucket mask 540A updated, a special check may be performed via compare-and-swap at least by checking the values of the active buffer counter 510F and the active writer counter 512F to ensure that it is safe to perform the shrink operation 538A on the identified bucket 560A. In this example, for example, the automatic memory management coordinator 526A may determine that the active buffer counter value 510F is zero, and that the active writer counter value 512F is also zero.

In some embodiments, the automatic memory management coordinator 526A may further optionally determine the version counter values of the buffers in the identified bucket 560A. For example, the automatic memory management coordinator 526A may determine that the version counter values are two (“2”) for buffer 514A, four (“4”) for buffer 516A, and six (“6”) for buffer 518A. In this example illustrated in FIG. 5F, an even-valued version counter value indicates that the buffer is available for writer processes to obtain and write data to, whereas an odd-valued version counter value indicates that the buffer is unavailable for writer processes to obtain. In this example, the version counter values for all three buffers of the bucket 560A are even numbers, and the automatic memory management coordinator 526A thus determines that the it is safe to shrink the bucket 560A because all of its buffers are available.

FIG. 5G illustrates an example that continues from FIG. 5F for an example IGA shrink task. More specifically, the IGA shrink task 536A may perform the IGA shrink operation on the IGA at least by first updating the active writer counter 512F from its then-current value of zero (“0”) to a different number that indicates that the bucket is locked. For example, the active writer counter 512F from its then-current value of zero (“0”) to a value that equals to the total number of buffers plus one (“1”) (four (“4”) in this example) for the updated active writer counter 512G in this example where the bucket 560A includes three buffers (3+1=4). Updating the active writer counter to a number that is not possible to be interpreted as the number of writers that are currently writing to buffer(s) in a bucket indicates that the bucket is locked (e.g., for deallocation) so as to prevent writer processes from obtaining and writing data to available buffers in the bucket 560A.

The IGA shrink task 536A may then finish the shrink operation 538A to deallocate the buffers 514A, 516A, and 518A in the bucket 560A from the IGA and shrink the IGA 550A into the shrunk IGA 550A′ as shown in FIG. 5H. In these examples illustrated in FIGS. 5F-5H, the bucket mask 540A is first updated to reflect the unavailability of the one or more buckets identified for deallocation before these one or more buckets are deallocated. In some embodiments, the bucket mask 540A is updated even before the active writer counter is updated (e.g., to the total number of buffers plus one).

### System Architecture Overview

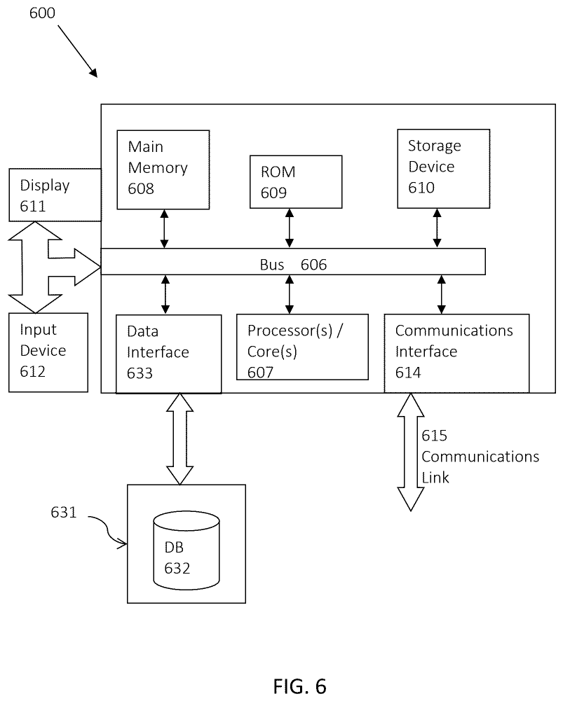

FIG. 6 is a block diagram of an illustrative computing system 600 suitable for implementing an embodiment of the present invention. Computer system 600 includes a bus 606 or other communication mechanism for communicating information, which interconnects subsystems and devices, such as processor 607, system memory 608 (e.g., RAM), static storage device 609 (e.g., ROM), disk drive 610 (e.g., magnetic or optical), communication interface 614 (e.g., modem or Ethernet card), display 611 (e.g., CRT or LCD), input device 612 (e.g., keyboard), and cursor control.

According to one embodiment of the invention, computer system 600 performs specific operations by processor 607 executing one or more sequences of one or more instructions contained in system memory 608. Such instructions may be read into system memory 608 from another computer readable/usable medium, such as static storage device 609 or disk drive 610. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 607 for execution. Such a medium may take many forms, including but not limited to, non-volatile media and volatile media. Non-volatile media includes, for example, optical or magnetic disks, such as disk drive 610. Volatile media includes dynamic memory, such as system memory 608.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, cloud-based storage, or any other medium from which a computer can read.

In an embodiment of the invention, execution of the sequences of instructions to practice the invention is performed by a single computer system 600. According to other embodiments of the invention, two or more computer systems 600 coupled by communication link 615 (e.g., LAN, PTSN, or wireless network) may perform the sequence of instructions required to practice the invention in coordination with one another.

Computer system 600 may transmit and receive messages, data, and instructions, including program, i.e., application code, through communication link 615 and communication interface 614. Received program code may be executed by processor 607 as it is received, and/or stored in disk drive 610, or other non-volatile storage for later execution. Data may be accessed from a database 632 that is maintained in a storage device 631, which is accessed using data interface 633.

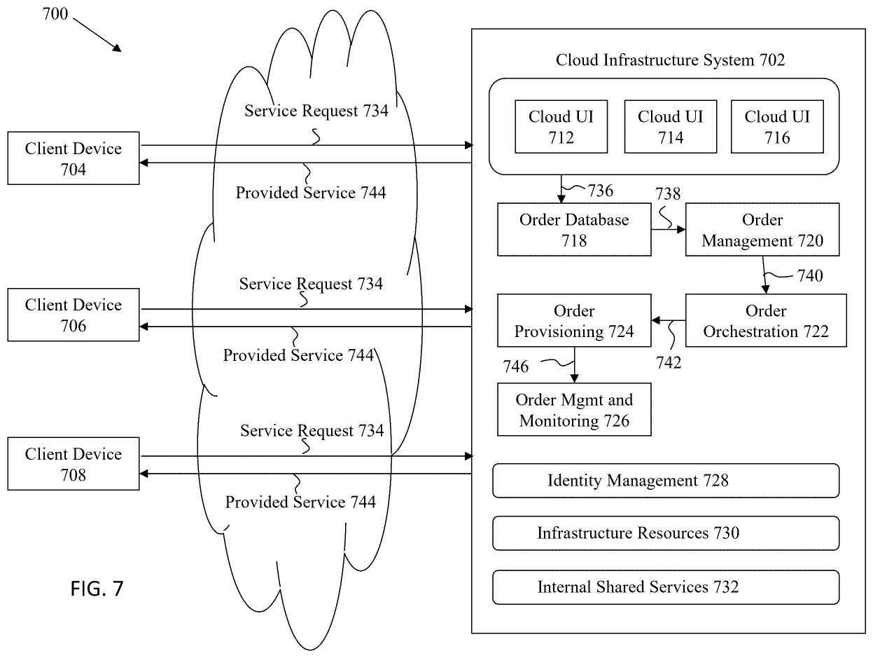

FIG. 7 is a simplified block diagram of one or more components of a system environment 700 by which services provided by one or more components of an embodiment system may be offered as cloud services, in accordance with an embodiment of the present disclosure. In the illustrated embodiment, system environment 700 includes one or more client computing devices 704, 706, and 708 that may be used by users to interact with a cloud infrastructure system 702 that provides cloud services. The client computing devices may be configured to operate a client application such as a web browser, a proprietary client application, or some other application, which may be used by a user of the client computing device to interact with cloud infrastructure system 702 to use services provided by cloud infrastructure system 702.

It should be appreciated that cloud infrastructure system 702 depicted in the figure may have other components than those depicted. Further, the embodiment shown in the figure is only one example of a cloud infrastructure system that may incorporate an embodiment of the invention. In some other embodiments, cloud infrastructure system 702 may have more or fewer components than shown in the figure, may combine two or more components, or may have a different configuration or arrangement of components.

Client computing devices 704, 706, and 708 may be devices similar to those described above for FIG. 6. Although system environment 700 is shown with three client computing devices, any number of client computing devices may be supported. Other devices such as devices with sensors, etc. may interact with cloud infrastructure system 702.

Network(s) 710 may facilitate communications and exchange of data between clients 704, 706, and 708 and cloud infrastructure system 702. Each network may be any type of network familiar to those skilled in the art that can support data communications using any of a variety of commercially-available protocols. Cloud infrastructure system 702 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 702 may include a suite of applications, middleware, and database service offerings that are delivered to a customer in a self-service, subscription-based, elastically scalable, reliable, highly available, and secure manner.

In various embodiments, cloud infrastructure system 702 may be adapted to automatically provision, manage and track a customer's subscription to services offered by cloud infrastructure system 702. Cloud infrastructure system 702 may provide the cloud services via different deployment models. For example, services may be provided under a public cloud model in which cloud infrastructure system 702 is owned by an organization selling cloud services and the services are made available to the general public or different industry enterprises. As another example, services may be provided under a private cloud model in which cloud infrastructure system 702 is operated solely for a single organization and may provide services for one or more entities within the organization. The cloud services may also be provided under a community cloud model in which cloud infrastructure system 702 and the services provided by cloud infrastructure system 702 are shared by several organizations in a related community. The cloud services may also be provided under a hybrid cloud model, which is a combination of two or more different models.

In some embodiments, the services provided by cloud infrastructure system 702 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 702. Cloud infrastructure system 702 then performs processing to provide the services in the customer's subscription order.

In some embodiments, the services provided by cloud infrastructure system 702 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 702 may also include infrastructure resources 730 for providing the resources used to provide various services to customers of the cloud infrastructure system. In one embodiment, infrastructure resources 730 may include pre-integrated and optimized combinations of hardware, such as servers, storage, and networking resources to execute the services provided by the PaaS platform and the SaaS platform.

In some embodiments, resources in cloud infrastructure system 702 may be shared by multiple users and dynamically re-allocated per demand. Additionally, resources may be allocated to users in different time zones. For example, cloud infrastructure system 730 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 732 may be provided that are shared by different components or modules of cloud infrastructure system 702 and by the services provided by cloud infrastructure system 702. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 702 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 702, and the like.

In one embodiment, as depicted in the figure, cloud management functionality may be provided by one or more modules, such as an order management module 720, an order orchestration module 722, an order provisioning module 724, an order management and monitoring module 726, and an identity management module 728. These modules may include or be provided using one or more computers and/or servers, which may be general purpose computers, specialized server computers, server farms, server clusters, or any other appropriate arrangement and/or combination.

In operation 734, a customer using a client device, such as client device 704, 706 or 708, may interact with cloud infrastructure system 702 by requesting one or more services provided by cloud infrastructure system 702 and placing an order for a subscription for one or more services offered by cloud infrastructure system 702. In certain embodiments, the customer may access a cloud User Interface (UI), cloud UI 712, cloud UI 714 and/or cloud UI 716 and place a subscription order via these UIs. The order information received by cloud infrastructure system 702 in response to the customer placing an order may include information identifying the customer and one or more services offered by the cloud infrastructure system 702 that the customer intends to subscribe to.

After an order has been placed by the customer, the order information is received via the cloud UIs, 712, 714 and/or 716. At operation 736, the order is stored in order database 718. Order database 718 can be one of several databases operated by cloud infrastructure system 718 and operated in conjunction with other system elements. At operation 738, the order information is forwarded to an order management module 720. In some instances, order management module 720 may be configured to perform billing and accounting functions related to the order, such as verifying the order, and upon verification, booking the order. At operation 740, information regarding the order is communicated to an order orchestration module 722. Order orchestration module 722 may utilize the order information to orchestrate the provisioning of services and resources for the order placed by the customer. In some instances, order orchestration module 722 may orchestrate the provisioning of resources to support the subscribed services using the services of order provisioning module 724.

In certain embodiments, order orchestration module 722 enables the management of business processes associated with each order and applies business logic to determine whether an order should proceed to provisioning. At operation 742, upon receiving an order for a new subscription, order orchestration module 722 sends a request to order provisioning module 724 to allocate resources and configure those resources needed to fulfill the subscription order. Order provisioning module 724 enables the allocation of resources for the services ordered by the customer. Order provisioning module 724 provides a level of abstraction between the cloud services provided by cloud infrastructure system 702 and the physical implementation layer that is used to provision the resources for providing the requested services. Order orchestration module 722 may thus be isolated from implementation details, such as whether or not services and resources are actually provisioned on the fly or pre-provisioned and only allocated/assigned upon request.

At operation 744, once the services and resources are provisioned, a notification of the provided service may be sent to customers on client devices 704, 706 and/or 708 by order provisioning module 724 of cloud infrastructure system 702.

At operation 746, the customer's subscription order may be managed and tracked by an order management and monitoring module 726. In some instances, order management and monitoring module 726 may be configured to collect usage statistics for the services in the subscription order, such as the amount of storage used, the amount data transferred, the number of users, and the amount of system up time and system down time.

In certain embodiments, cloud infrastructure system 702 may include an identity management module 728. Identity management module 728 may be configured to provide identity services, such as access management and authorization services in cloud infrastructure system 702. In some embodiments, identity management module 728 may control information about customers who wish to utilize the services provided by cloud infrastructure system 702. Such information can include information that authenticates the identities of such customers and information that describes which actions those customers are authorized to perform relative to various system resources (e.g., files, directories, applications, communication ports, memory segments, etc.) Identity management module 728 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

### Pseudo Code for Example Implementations

New session (writer) inserting data:

ingestData(data)
{
buffer = getBuffer( ); //get buffer
cacheBuffer(buffer); //cache at writer
addToWriteMeta(buffer); //can be flushed if it meets constraints
writeData(buffer, data);
atomic_dec(iga[bucket_id])−>active_writers); //indicate writer exists from bucket
getBuffer
{
do
{
hash = getHash(...);
bucket_id = hash % bucket_mask; // mask is a limit on the active bucket
lockNoWait(iga[bucket_id]); //will block de-allocation of bucket
for (buffer = iga[bucket_ic]; buffer ; buffer = buffer−>next)
if {buffer−>sessionid == 0)
{
buffer−>seesionid = sessionid; // marks the buffer is taken
atomic_inc(iga[buckei_id]−>active_buffers); // no. of buffer in use
unlock(iga[bucket_id]);
return buffer;
}
if (multiple_attempts)
sleep(short-time); // iga might be full
} while (1); //loop until we get buffer
}
Existing session (e.g., writer process) accessing a cached buffer yet
unwillingly giving up the buffer & flusher process has taken up the cached buffer:
ingestData(data, objId)
{
buffer = getCachedBuffer(objId);
butter = getBuffer( );
writeData(buffer, data);
}
getCachedBulter(objId)
{
cache = getCache(objId); // cache by obj-type
bucket_meta = cache−>bucket_meta;
do
{
active_writes = bucket_meta−>active_writes; // active writers in the buckets
total_buffers = bucket_meta−>total_buffers; // buffers in bucket
if (active_writes <= total_buffers) // act_writes is less than buffers, do CAS
res = CAS(bucket_meta−>active_writes, bucket_,eta−>active_ writes + 1);
// if CAS succeeds, Writer can access the cached buffer safely
else
return NULL; // bucket is de-allocated
} while (lres);
cached_buffer = fetchBuffer(cache);
if (cache−>version != cached_buffer−>version) // check buffer version
return NULL; // indicates, the buffers is taken by flush / flushed
return cached_buffer;
}

Flusher process flushing a full buffer (e.g., buffer is full)—Writer processes add buffer to write chain—other writer processes in the same bucket-flusher process takes buffer from writer process using version number, while writer process tries to add buffer to flush chain:

ingestData(data, objId)
{
if (buffer−>avail_space < data) // butter is full
{
dropCache(bulter}; // drop from cache Writer cache
addBufferTo writeChain( ); // add to write chain
butter = NULL; // get new buffer
}
buffer = getBuffer( );
writeData(buffer, data);
}
addBufferToWriteChain( )
{
flush_meta = getFlushMeta( );
lock(tlush_meta−>write_chain, res):
appendLast(flush_meta−>write_chain, flush_meta−>buf};
unlock(flush_meta−>write_chain);
}
flushBuffer(flush_meta)
{
If (flush_meta −>write_chain)
{
lock(flush_meta−>write_chain);
flush_meta−>flush_chain = flush_meta−>wrrte_chain;
// convert write chain to flush chain
unlocktflush_meta−>write_chain]
}
if (canFlush(fiush_meta−>currerit_buf))
atomic_inc_if_even(flush_meta−>current_buf−>version, res);
// get Writer cached butter to flush
if (res) // append to flush chain if CAS succeeds
appendLast(flush_meta−>flush_chain, flush_meta−>current_buf);
for (buffer = flush_meta−>flush_chain; buffer; buffer = butter−>next)
for (i = 0; i< buffer−>rows; i ++;)
flushFlow( getFlow (buffer, row_sz) );
}

In the absence of other writers in the bucket-flusher process flushing without writer processes:

flushBuffer(flush_meta)
{
if (flush_meta−>write_chain)
flush_meta−>flush_chain = flush_meta−>write_chain;
if (canFlush(flush_meta−>current_buf))
atomic_inc_if_even(flush_meta−>current_buf−>version, res);
if (res)
appendLast(tlush_meta−>flush_chain, tlush_meta−>current_but);
//Flush takes current_buf as well (version is updated by flusher)
for (butter = ilush_meta−>flush_chain; buffer; bufier = buffer−>next)
{
for (i = 0; i < buffer−>rows; i ++;)
flushFtow( getFiow (buffer, row_sz) );
buffer−>sessionid=O;
bucket_id = buffer−>bucket_id;
atomr'c_dec(iga[bucket_id]−>active_buffers); //AMM can release
buffer
}
}

New session (writer process) inserting data when IGA is being grown:

ingestData(data, objId)
{
Buffer = getBuffer( );
writeData(buffer, data);
}
getBuffer( )
{
do
{
hash = getHash(....);
bucket_id = hash % iga−>bucket_mask; // read before update
/* bucket_id = 128, read mask before update */
For (buffer = iga[bucket_id]; buffer ; buffer = buffer−>next)
If (buffer−>sessionid == 0)
{
....
Return buffer; //buffer from 128th bucket
}
} while (1);
}
grow_iga( );
{
Size = iga_size_adaptive_growth_percent/100;
New_buckets = (size / init_size); // new buckets 23
allocateGranules(size);
for (I = iga−>bucket_mask + 1; I < new_buckets; 9++)
{
allocateBuffersFromgranules(iga[i]);
}
Iga_size +=size;
Iga−>bucket_mask +− new_buckets;
}
Amm( )
{
if (iga_load> growth_load_percent)
grow_iga( );
}
if (buffer−>avail_space < data) // butter is full
{
dropCache(bulter}; // drop from cache Writer cache
addBufferTo writeChain( ); // add to write chain
butter = NULL; // get new buffer
}
buffer = getBuffer( );
writeData(buffer, data);
}
addBufferToWriteChain( )
{
flush_meta = getFlushMeta( );
lock(tlush_meta−>write_chain, res):
appendLast(flush_meta−>write_chain, flush_meta−>buf};
unlock(flush_meta−>write_chain);
}
flushBuffer(flush_meta)
{
If (flush_meta −>write_chain)
{
lock(flush_meta−>write_chain);
flush_meta−>flush_chain = flush_meta−>wrrte_chain;
// convert write chain to flush chain
unlocktflush_meta−>write_chain]
}
if (canFlush(fiush_meta−>currerit_buf))
atomic_inc_if_even(flush_meta−>current_buf−>version, res);
// get Writer cached butter to flush
if (res) // append to flush chain if CAS succeeds
appendLast(flush_meta−>flush_chain, flush_meta−>current_buf);
for (buffer = flush_meta−>flush_chain; buffer; buffer = butter−>next)
for (i = 0; i< buffer−>rows; i ++;)
flushFlow( getFlow (buffer, row_sz) );
}

Session falls into a newer bucket (post IGA growth)—Writer process reads new bucket mask:

getBufier( )
{
do
{
hash = getHash(....);
// mask −> 127
// mask −> 151
bucket_id = hash % iga−>bucket_mask; //′ reads new mask
/* bucket_id = 147, bucket selected from expanded area */
tor (butter = iga[bucket_id]; buffer ; buffer = butter−>next)
if (buffer−>sessionid == 0)
{
....
return buffer; // buffer from 151th bucket
}
}while (1);
}
grow_iga( )
{
.
.
.
size = iga_size * _iga_adaptive_growth_percentI100;
new_buckets = (size /init_size); // new buckets 23
iga−>bucket_mask += new_buckets; //new-mask = 151
}
amm( )
{
{ if (iga_load > growth_|oad_percent)
grow_iga( );
}

Session (writer process) inserting data into a bucket while an IGA shrink task is trying to free buffers from that bucket—existing writer process—writer process increases active_writers so deallocation is skipped at shrink:

```
ingestData(data, objId)
{
buffer = getCachedBuffer(objId);
buffer = getBuffer( );
writeData(buffer, data);
}
getCachedBuffer( )
{
cache = getCache(objId);
bucket_meta = cache−>bucket_meta; //has buffer from bucket 147;
do
{
active_writers = =bucket_meta−>active_writers;
total buffers = bucket_meta−>total_buffers;
if (active_writes<=total_buffers) // do CAS, writers has less or equal bufs
  res = CAS(tive_writes, active_writes + 1); //CAS succeeds
    //writer can access the cached buffer safely
else return NULL; // bucket is de-allocated
} while (!res && ++counter != 10); // spin 10 times or get new buffer
If (!res) return NULL;
....
return getBuffer(cache);
}
shrink_iga( );
{
size = iga_size *_adaptive_shrink_percent/100;
for (i = iga−>bucket_mask; i > iga_min_size; I −−)
{
Iga[i]−>state = INACTIVE; //block using buffers from the bucket
}
Iga−>bucket_mask −= nbuckets; // mask updated to 140
RangeLock(iga[first_bucket], iga[iga−>total_bucket]); //locks 141 to 167th buckets
....
....
for (I = iga−>bucket_mask − nbuckets; I < iga−>total_buckets; i++)
{
if (iga[i]−>active_buffers != 0 ∥ iga[i]−>active_writers !=0)
return; //bucket 147 active_writers will not be 0 − writer got a buffer
// Do nothing, go to sleep
}
}
```

New writer process—writer process reads old bucket mask but sees the bucket status as INACTIVE, so gets a new bucket in the next attempt:

getBuffer
{
do
{
hash = getHash(...);
bucket_id = hash % iga−>bucket_mask; // mask = 147
/* bucket_id 147th is about to deallocate*/
lockNoWait(iga[bucket]); //locks the bucket
if {iga[bucket_id]−>state == INACTIVE} // status is INACTIVE
continue; //try different bucket
for (buffer = iga[bucket_id]; buffer ; buffer = buffer−>next)
if (buffer−>sessionid == 0)
{
atomic_inc(iga[buckei_id]−>active_buffers); // no. of buffer in use
atomic_inc(iga[buckei_id]−>active_writers);
unlock(iga[bucket]);
return buffer; // buffer from 147th bucket
}
} while(1);
shrink_iga( );
{
size = iga_size *_ adaptive_shrink_percent/100;
for (i = iga−>bucket_mask; i > iga_min_size; i −−)
{
iga[i]−>state = INACTIVE; //block writers accessing the bucket
if (act_size >= size)
break;
nbuckets ++; // inc mask until we reach shrink size
}
Iga−>bucket_mask −=nbuckets; // mask old = 167 new = 140
first_bucket = iga−>bucket_mask − nbuckets;
RangeLock(iga[first_bucket], iga[iga−>total_bucket]); //locks 141 to 167th buckets
....
....
for (i = iga−>bucket_mask − nbuckets; I < iga−>total_buckets; i++)
{
if (iga[i]−>active_buffers != 0 ∥ iga[i]−>active_writers != 0)
return; //bucket 147 active_buffer/active_writers will not be 0 − writer got a buffer
deallocateGranules( );
freebuckets( );
....
....
}

We claim:

1. A method, comprising:
identifying a memory area of a global memory of a computing system, the memory area comprising a buffer memory area and allocated for ingesting data for a database;
identifying a persistent storage device into which data stored in the memory area is to be flushed;
determining a predicted ingest rate and a predicted flush rate for the memory area of the global memory for the database; and
adaptively resizing the memory area at least by executing a memory management task on the memory area based at least in part upon the predicted ingest rate and the predicted flush rate.

2. The method of claim 1, determining the predicted ingest rate and the predicted flush rate comprising:
determining the memory management task for the memory area based at least in part upon the predicted ingest rate and the predicted flush rate;
modifying a buffer accessibility map based at least in part upon the memory management task;
determining an adaptive growth criterion and an adaptive growth size or rate for the memory area; and
determining an adaptive shrink criterion and an adaptive shrink size or rate for the memory area.

3. The method of claim 1, determining the predicted ingest rate and the predicted flush rate comprising:
identifying multiple snapshots pertaining to ingestion of first data into the memory area or flush of second data to the database or a persistent storage device therefor; and
for a snapshot of the multiple snapshots, determining an ingest rate and a flush rate, wherein multiple ingest rates and multiple flush rates are respectively determined for the multiple snapshots.

4. The method of claim 3, determining the predicted ingest rate and the predicted flush rate comprising:
determining a statistical ingest rate as the predicted ingest rate using at least the ingest rate determined for the snapshot of the multiple snapshots; and
determining a statistical flush rate as the predicted flush rate using at least the flush rate determined for the snapshot of the multiple snapshots.

5. The method of claim 4, determining the predicted ingest rate and the predicted flush rate comprising:
training a model into a trained model using training data for data ingestion and data flushing, wherein the training data comprises the predicted ingest rate and the predicted flush rate; and
determining, by the trained model, the predicted ingest rate and the predicted flush rate.

6. The method of claim 4, determining the memory management task for the memory area comprising:
comparing the statistical ingest rate to or with the statistical flush rate for generating a comparison result; and
determining the memory management task based at least in part upon the comparison result.

7. The method of claim 4, determining the statistical ingest rate or the statistical flush rate comprising:
determining one or more ingestion metrics or characteristics for ingestion of the first data or one or more flush metrics or characteristics for flushing the second data;
determining respective weights or multipliers for the multiple snapshots; and
determining the statistical ingest rate based at least in part the multiple ingest rates and the respective weights or multipliers or the statistical flush rate based at least in part the multiple flush rates and the respective weights or multipliers.

8. The method of claim 4, determining the memory management task for the memory area comprising:
determining total waited ingestion time after shrinkage of the memory area; and
determining whether to override the memory management task based at least in part upon whether the total waited ingestion time after the shrinkage of the memory area exceeds ac threshold.

9. The method of claim 4, determining the statistical ingest rate or the statistical flush rate comprising:
determining a plurality of attributes pertaining to the database; and
determining a signature for an object of a plurality of objects, wherein the plurality of objects comprise data stored in the memory area, and a plurality of signatures are respectively determined for the plurality of objects, wherein the signature comprises a pattern of multiple bits each of which respectively represents presence or absence of a respective attribute of the plurality of attributes.

10. The method of claim 9, determining the statistical ingest rate or the statistical flush rate further comprising:
for a signature of the plurality of signatures or an attribute of the plurality of attributes, identifying the snapshot from the multiple snapshots; and
for the signature identified from the plurality of signatures and the snapshot identified from the multiple snapshots, determining the ingest rate and the flush rate based at least in part upon the plurality of attributes, wherein the multiple ingest rates and the multiple flush rates are respectively determined for the multiple snapshots.

11. The method of claim 10, determining the statistical ingest rate or the statistical flush rate further comprising:
determining the statistical ingest rate at least by performing a first statistical operation on the multiple ingest rates; and
determining the statistical flush rate at least by performing a second statistical operation on the multiple flush rates.

12. The method of claim 11, further comprising:
determining a total number of tables that are enabled or are to be enabled for ingestion of the first data;
determining the statistical ingest rate for the signature of the plurality of signatures based at least in part upon a count of objects for the signature across the multiple snapshots and a current number of objects for signature across the multiple snapshots; and
determining the statistical flush rate for the signature of the plurality of signatures based at least in part upon the count of objects for the signature across the multiple snapshots and the current number of objects for signature across the multiple snapshots.

13. A system, comprising:
a processor;
a memory storing a sequence of instructions which, when executed by the processor, causes the processor to perform a set of acts, the set of acts comprising:
identifying a memory area of a global memory of a computing system, the memory area comprising a buffer memory area and allocated for ingesting data for a database;
identifying a persistent storage device into which data stored in the memory area is to be flushed;
determining a predicted ingest rate and a predicted flush rate for a memory area of a global memory for a database; and
adaptively resizing the memory area at least by executing the memory management task on the memory area based at least in part upon the predicted ingest rate and the predicted flush rate.

14. The system of claim 13, wherein the memory further comprises the sequence of instructions which, when executed by the processor, causes the processor to perform the set of acts, the set of acts further comprising:
determining the memory management task for the memory area based at least in part upon the predicted ingest rate and the predicted flush rate;
modifying a buffer accessibility map based at least in part upon the memory management task;
identifying multiple snapshots pertaining to ingestion of first data into the memory area or flush of second data to the database or a persistent storage device therefor; and
for a snapshot of the multiple snapshots, determining an ingest rate and a flush rate, wherein multiple ingest rates and multiple flush rates are respectively determined for the multiple snapshots.

15. The system of claim 14, wherein the memory further comprises the sequence of instructions which, when executed by the processor, causes the processor to perform the set of acts, the set of acts further comprising:
determining a plurality of attributes pertaining to the database; and
determining a signature for an object of a plurality of objects, wherein the plurality of objects comprise data stored in the memory area, and a plurality of signatures are respectively determined for the plurality of objects, wherein the signature comprises a pattern of multiple bits each of which respectively represents presence or absence of a respective attribute of the plurality of attributes.

16. The system of claim 15, wherein the memory further comprises the sequence of instructions which, when executed by the processor, causes the processor to perform the set of acts, the set of acts further comprising:
for a signature of the plurality of signatures or an attribute of the plurality of attributes, identifying the snapshot from the multiple snapshots;
for the signature identified from the plurality of signatures and the snapshot identified from the multiple snapshots, determining the ingest rate and the flush rate, wherein the multiple ingest rates and the multiple flush rates are respectively determined for the multiple snapshots;
determining the statistical ingest rate at least by performing a first statistical operation on the multiple ingest rates; and
determining the statistical flush rate at least by performing a second statistical operation on the multiple flush rates.

17. A computer program product embodied on a non-transitory computer readable medium, the non-transitory computer readable medium having stored thereon a sequence of instructions which, when executed by a processor, causes the processor to execute a set of acts, the set of acts comprising:
identifying a memory area of a global memory of a computing system, the memory area comprising a buffer memory area and allocated for ingesting data for a database;
identifying a persistent storage device into which data stored in the memory area is to be flushed;
determining a predicted ingest rate and a predicted flush rate for a memory area of a global memory for a database;
adaptively resizing the memory area at least by executing the memory management task on the memory area.

18. The computer program product of claim 17, wherein the non-transitory computer readable medium further comprises the sequence of instructions which, when executed by the processor, causes the processor to perform the set of acts, the set of acts further comprising:
determining the memory management task for the memory area based at least in part upon the predicted ingest rate and the predicted flush rate;
modifying a buffer accessibility map based at least in part upon the memory management task;
identifying multiple snapshots pertaining to ingestion of first data into the memory area or flush of second data to the database or a persistent storage device therefor; and
for a snapshot of the multiple snapshots, determining an ingest rate and a flush rate, wherein multiple ingest rates and multiple flush rates are respectively determined for the multiple snapshots.

19. The computer program product of claim 18, wherein the non-transitory computer readable medium further comprises the sequence of instructions which, when executed by the processor, causes the processor to perform the set of acts, the set of acts further comprising:
determining a plurality of attributes pertaining to the database; and
determining a signature for an object of a plurality of objects, wherein the plurality of objects comprise data stored in the memory area, and a plurality of signatures are respectively determined for the plurality of objects, wherein the signature comprises a pattern of multiple bits each of which respectively represents presence or absence of a respective attribute of the plurality of attributes.

20. The computer program product of claim 19, wherein the non-transitory computer readable medium further comprises the sequence of instructions which, when executed by the processor, causes the processor to perform the set of acts, the set of acts further comprising:
for a signature of the plurality of signatures or an attribute of the plurality of attributes, identifying the snapshot from the multiple snapshots;
for the signature identified from the plurality of signatures and the snapshot identified from the multiple snapshots, determining the ingest rate and the flush rate, wherein the multiple ingest rates and the multiple flush rates are respectively determined for the multiple snapshots;
determining the statistical ingest rate at least by performing a first statistical operation on the multiple ingest rates; and
determining the statistical flush rate at least by performing a second statistical operation on the multiple flush rates.
